(19) United States
(12) Patent Application Publication
(10) Pub. No.: US 2024/0122685 A1
(43) Pub. Date: Apr. 18, 2024

(54) METHOD FOR SIZING A DENTAL PROSTHESIS

(71) Applicant: Rami Salloum, Bethlehem, PA (US)

(72) Inventor: Rami Salloum, Bethlehem, PA (US)

(21) Appl. No.: 18/483,646

(22) Filed: Oct. 10, 2023

Related U.S. Application Data
(60) Provisional application No. 63/415,495, filed on Oct. 12, 2022.

(51) Int. Cl. A61C 8/00; A61C 9/00; A61C 13/34

(52) U.S. Cl. CPC A61C 8/0095; A61C 8/0001; A61C 9/0053; A61C 13/34

(57) ABSTRACT

A method for sizing an implant-supported dental prosthesis. A bite impression is made of the edentulous area to which the dental prosthesis will be attached. The bite impression contains coping impressions oriented to attach to the respective implants. The coping impressions are connected with connector plates, all embedded in a curable impression material. The bite impression is used to cast a physical model, which contains lab analogues corresponding in relative location and orientation with the dental implants. An anterior scanning device is attached in vivo to two anterior implants, and fitted with scannable markers indicating the patient's anatomical vertical dimension of occlusion and midline. A hybrid in vivo/ex vivo digital scan is created by first in vivo scanning the anterior scanning device with bite followed by ex vivo digital recording the physical model to which the anterior scanning device has been transferred.

### CROSS REFERENCE TO RELATED APPLICATIONS

This application claims priority to Provisional Patent Application U.S. 63/415,495 filed on Oct. 12, 2022, the entire disclosure of which is hereby incorporated by reference and relied upon.

### BACKGROUND OF THE INVENTION

### Field of the Invention

The invention relates generally to a method for determining the size and shape of a dental prosthesis, and more particularly to a hybrid in vivo/ex vivo method for determining the size and shape of a full arch implant restoration.

### Description of Related Art

Tooth loss is a psychological, functional, esthetically, and general health problem. The edentulism is connected with higher risk of early mortality and that prosthetic rehabilitation of edentulism leads to higher quality of life and reduces morbidity. The implant supported fixed prosthesis leads to higher patient satisfaction and higher life quality. The time to the prosthesis delivery and the time when patient is edentulous, should be as short as possible. Passive fit off the prosthesis is crucial for long term biological success and can prevent technical complications.

The landscape of dental implant therapy for full-arch rehabilitation has witnessed a surge in popularity since the advent of dental implants. Today's patients have come to anticipate not only effective treatments, but also streamlined procedures that ensure comfort and aesthetic excellence. In response to these evolving expectations and with mounting evidence suggesting that immediate loading of full-arch implant prostheses does not compromise implant longevity, dental professionals have embraced the concept of immediate-load provisionalization for implant-supported dental prostheses. Yet, the conventional, analog methods for fabricating these provisional restorations have long presented challenges, which lead to extended chair time and increased potential for complications.

In parallel, the rise of digital dentistry has marked a pivotal paradigm shift in the field. Digital tools empower dental practitioners to capture accurate, meticulous impressions while circumventing the need for conventional and often cumbersome impression materials. Digital restoration design empowers providers to exert direct control over the quality of their restorations, allowing for swift fabrication and same-day delivery—a feature that resonates with patients seeking efficient and discomfort-free treatment options. The integration of digital dentistry into today's practice holds the potential to attract new patients by promising efficient treatment and eliminating the discomfort typically associated with conventional analog impression methods. Despite the remarkable improvements offered by digital dentistry, however, there remain challenges posed by these techniques as well when it comes to restoration of the implant-supported full-arch.

Several technologies have been introduced as a means to address these challenges within the world of digital dentistry. Cutting-edge techniques like photogrammetry and facial scanning are examples of such introductions.

Photogrammetry, a method that involves capturing and analyzing a series of photographs to generate precise 3D models, has emerged as a promising tool in dentistry. Photogrammetry improves upon standard digital dental scanning by utilizing fixed physical points by which scans can be verified. While photogrammetry holds promise in dentistry for creating detailed 3D models, its limitations related to verifiability, complexity, patient cooperation, and other factors should be carefully considered in the decision to implement it within clinical workflows.

Facial scanning is another pivotal application within digital dentistry. This technique enables the capture of a patient's facial features, allowing for the integration of facial aesthetics with dental restoration design. By incorporating facial scanning into the treatment workflow, providers can tailor restorations to harmonize with a patient's unique facial features, enhancing both function and aesthetics. However, the implementation of facial scanning and its integration with dental procedures pose challenges that warrant consideration.

While these advancements hold immense promise, they also introduce certain complexities and challenges. The integration of photogrammetry and facial scanning into the field of full-arch implant-supported rehabilitation aims to enhance the speed and success of treatment while minimizing chair time and complication risk. However, the intricate nature of these techniques requires training, a deep understanding, and increased costs to achieve optimal outcomes.

To digitally design a provisional prosthesis for immediate post-surgery restoration, obtaining accurate digital impressions of the arch of interest, opposing arch, and occlusal relationship is essential. However, traditional digital scanning has presented several challenges for practitioners. The challenges of immediate restoration of the full-arch implant prosthesis include:
1. Inaccuracy of edentulous arch scan data. Intraoral scanners often struggle to collect accurate scan data in the absence of fixed dentition. Additionally, the presence of blood in the surgical site immediately post-procedure can pose a further challenge to the accuracy of a digital scan.
2. Capturing the occlusal relationship. The precise scan of the jaw relationship in centric relation (CR) position at the desired vertical dimension is crucial for designing an ideal full-arch implant-supported prosthesis. However, without fixed dentition remaining in the arch of interest, the patient is unable to occlude. This renders it difficult to determine the correct vertical dimension in CR.
3. Inaccuracies involved in the merging of intraoral and extraoral scans. Research has indicated that extraoral desktop digital scanning of models provides more precise digital files for full-arch implant-supported prostheses. Therefore, to achieve maximum accuracy for full-arch conversion while maintaining the benefits of digital impression methods, practitioners must combine information from extraoral model scans and intraoral scans. However, this presents a difficulty, as digital technology may face challenges in merging two scans of an edentulous arch without fixed points of similarity, such as teeth.

Typically, digital software merges two scans of the same arch by recognizing fixed points, often teeth, present in both scans. However, finding identical fixed points in two scans of an edentulous arch proves to be a genuine challenge. Inaccurate data merging between intraoral and extraoral scans can defeat the goal of accuracy that is inherent in using extraoral desktop scanning to capture a full arch.

Additional measures, such as photogrammetry, have been introduced to the field of digital dentistry in an attempt to mitigate these inaccuracies by providing fixed points of reference to the scan. However, these measures can burden the practitioner and patient with additional procedure time and cost.

Numerous attempts have been proposed to address these issues but failed to achieve a truly practical solution. Examples include:
US Patent Publication No. 2021/0322138 in the name of Zhou et al.
U.S. Pat. No. 11,259,902 in the name of Gerstenkamp
U.S. Pat. No. 10,925,699 in the name of Kim et al.

A novel and simple technique is needed to overcome these challenges. There is a need in the art for a simplified approach to fabrication of the accurate implant supported dental prosthesis, preferably in the day of or shortly after the implant surgery.

### BRIEF SUMMARY OF THE INVENTION

The invention contemplates a hybrid in vivo/ex vivo method for determining the size and shape of a dental prosthesis to be fixed to an edentulous site in a patient's mouth in which have been placed a plurality of dental implants in the mandible or maxilla, the plurality of implants including first and second anterior implants located near the area designated for incisor teeth, said method comprising the steps of:
in vivo attaching a coping impression to each implant so that there is a space between each coping impression and the next adjacent coping impression, the coping impression attached to the first anterior implant comprising a first anterior coping impression, the coping impression attached to the second anterior implant comprising a second anterior coping impression,
in vivo embedding the coping impressions within a curable impression material, the embedding step including overlaying the edentulous site with the impression material, solidifying the impression material into a rigid monolithic bite impression containing the coping impressions, the bite impression having a negative impression of the edentulous site,
relocating the bite impression from in vivo to ex vivo, the negative impression of the edentulous site exposing each coping impression,
ex vivo connecting a lab analogue to each coping impression, the lab analogue attached to the first anterior coping impression comprising a first anterior lab analogue, the lab analogue attached to the second anterior coping impression comprising a second anterior lab analogue,
ex vivo casting a physical model from the bite impression, the casting step including encasing the lab analogues in a curable compound, the physical model comprising a generally exact scale replica of the edentulous site with each encased lab analogue corresponding in relative location and orientation with a respective one of the dental implants, the physical model having the first anterior lab analogue corresponding in relative location and orientation to the first anterior implant and the second anterior lab analogue corresponding in relative location and orientation to the second anterior implant,
in vivo attaching an anterior scanning device (ASD) to the first and second anterior implants, affixing a scannable marker on the ASD to indicate at least one of a vertical dimension of occlusion and a midline,
creating a hybrid in vivo/ex vivo digital scan of the ASD capturing the scannable marker, the step of creating a hybrid in vivo/ex vivo digital scan including in vivo digitally recording the ASD using an intraoral scanner, and in vivo detaching the ASD from the first and second anterior implants, and ex vivo attaching the ASD to the physical model, and ex vivo scanning the physical model with attached ASD.

The invention describes an efficient, simple and effective digital approach to immediate provisionalization of an implant-supported prosthesis. The method takes advantage of a single verified and unmounted working model for the arch of interest to aid in the accuracy of scanning and enables the practitioner to verify the fit of the prosthesis. The innovative technique requires minimal chair time and cost to the provider and reduces patient discomfort and complication risk. The method avoids many challenges posed by prior art digital and analog techniques to the immediate provisionalization of the implant-supported prosthetic.

### BRIEF DESCRIPTION OF THE SEVERAL VIEWS OF THE DRAWINGS

These and other features and advantages of the present invention will become more readily appreciated when considered in connection with the following detailed description and appended drawings, wherein:

FIG. 1 is a simplified diagram outlining the steps of the invention;

FIG. 2 shows a dental prosthesis in the exemplary form of a full arch restoration, hovering over an edentulous mandibular site fitted with a series of implants;

FIG. 3 is an illustration prepared from a photograph of a dental operation showing an edentulous mandible, as in FIG. 2, where coping impressions have been attached to the implants;

FIG. 4 is a simplified perspective illustration showing four coping impressions set at various angular orientations simulating a possible placement situation in a patient, with three connector plates positioned joining the coping impressions in daisy-chain fashion;

FIG. 5 is another illustration prepared from a photograph of a dental operation as in FIG. 3, showing the connector plates overlapping one another and spot-bonded to the coping impressions in vivo;

FIG. 6 shows a further progression of the surgical procedure from FIG. 5, in which the connector plates together with the upstanding ends of the coping impressions and the bonding resin are embedded within a curable impression material to form a bite impression;

FIG. 7 shows the bite impression ex vivo, with lab analogues attached to the coping impressions, interconnected with connector plates and spot-bonded together as a preparatory step to casting a physical model;

FIG. 8 depicts, ex vivo, a physical model cast from the bite impression of FIG. 7;

FIG. 9 is an illustration prepared from a photograph of a dental operation showing the in vivo process of creating a custom anterior scanning device;

FIG. 10 is a front elevation of the anterior scanning device of FIG. 9, showing the patient's occluding teeth contacting built-up regions of the anterior scanning device so as to establish a vertical dimension of occlusion;

FIG. 11 shows an exemplary representation of a hand-held intraoral scanner being used to create the in vivo portion of a hybrid in vivo/ex vivo digital file, a graphic representation of which is output to a nearby display screen;

FIG. 12 shows the physical model of FIG. 8 together with the attached anterior scanning device being scanned to create the ex vivo portion of a hybrid in vivo/ex vivo digital file;

FIGS. 13A-G depict the process of capturing three distinct scan files that are linked and merged into a highly accurate digital representation of the patient's mouth with teeth in occlusion superimposing the anterior scanning device and scan bodies to enable the rapid design, fabrication and staining of a prosthesis;

FIG. 14 shows a finished dental prosthesis constructed using the hybrid in vivo/ex vivo digital scan, fastened to the physical model for test fitting;

FIG. 15 depicts an initial step in the process of creating the anterior scanning device according to a first alternative embodiment;

FIG. 16 shows a completed anterior scanning device according to the first alternative embodiment;

FIG. 17 depicts an optional guided surgery technique, in which a bone foundation guide is anchored in place over the edentulous site;

FIG. 18 is a further progression of the surgical procedure from FIG. 17, depicting an implant drilling guide affixed to the bone foundation guide;

FIG. 19 is a perspective view showing a custom connector plate supported in the bone foundation guide of FIG. 17 with the ends of coping impressions protruding through the custom connector plate;

FIG. 20 illustrates a further step in preparation for making a bite impression, in which the connector plate of FIG. 18 is bonded to the protruding ends of the coping impressions;

FIG. 21 depicts the anterior scanning device according to a second alternative embodiment being installed via the bone foundation guide of FIG. 17; and

FIG. 22 shows the completed anterior scanning device according to the second alternative embodiment.

### DETAILED DESCRIPTION OF THE INVENTION

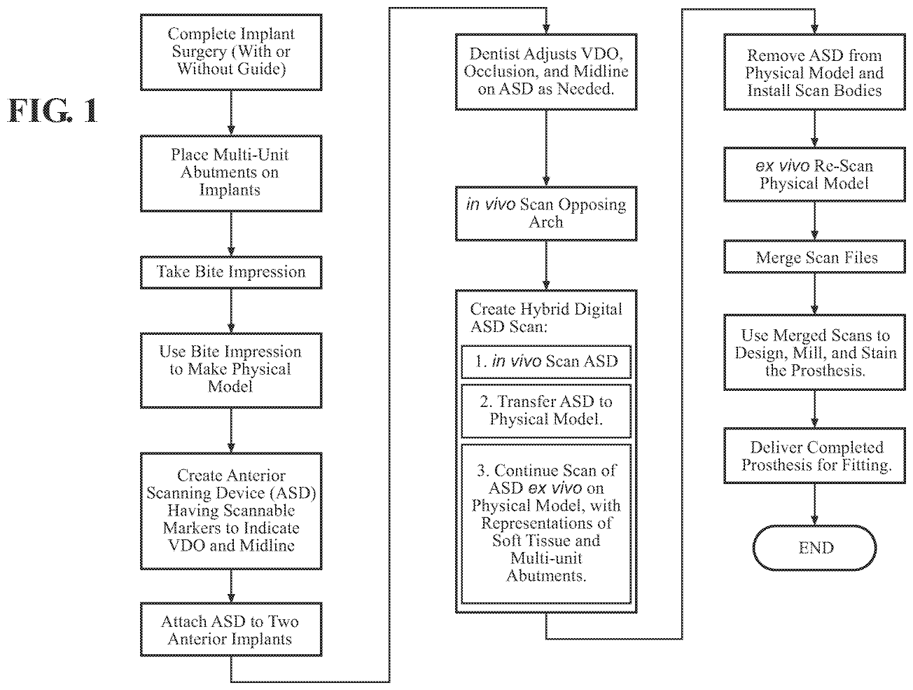

Referring to the figures, wherein like numerals indicate like or corresponding parts throughout the several views, a hybrid in vivo/ex vivo method for determining the size and shape of a dental prosthesis is showing in simplified schematic form in FIG. 1. The term in vivo is used to refer to any step or operation taking place intraorally, that is inside the patient's mouth. The terms in vivo and intraoral may be used interchangeably. In contrast, the term ex vivo refers to any step or operation taking place extraorally—outside the patient's mouth. The terms ex vivo and extraoral may be used interchangeably. The dental prosthesis is of the type to be fixed to an edentulous site inside a patient's mouth. In one example, the dental prosthesis is a bridge and the method is employed in connection with a rapid conversion process for dental arches and bridges.

The method comprises a series of steps or actions, some of which are carried out in vivo, that is inside the patient's mouth, and other steps or actions carried out ex vivo, i.e., outside the patient's mouth, such as on a worktable. The method is also paired with certain antecedent preparatory steps and certain subsequent or following steps. One such antecedent step includes pre-surgical planning. Depending on the patient, pre-surgical planning may include an intraoral digital scan of the teeth and soft tissues and/or cone-beam computed tomography (CBCT) scans. Practitioners then formulate a comprehensive implant positioning strategy, factoring in both bone availability evident in CBCT scans and desired prosthetic tooth alignment discernible in digital scans. Perhaps using commercially available implant-planning software, implant positions are planned based on the ideal prosthetic esthetics, midline, and vertical dimension, as well as bone volume. To aid in the surgery, a custom tooth-borne guide, or in fully edentulous cases a bone foundation guide, may be meticulously designed and milled. The drilling guide will be compatible with the applicable guided implant surgery system.

Another such antecedent step includes in vivo placing a plurality of dental implants 24 in the mandible or maxilla inside the patient's mouth, in the area of the edentulous site to which the dental prosthesis will be affixed. In some cases, the dental implants 24 are placed several days, weeks or even months in advance. In other cases, it may be possible to place the dental implants 24 on the same day that the size and shape of the dental prosthesis is determined according to the present method. That is to say, the method of this invention lends itself to a wide range of uses adaptable to the situation and professional judgement of the attending caregiver, including but not limited to same-day placement of implants and sizing of the dental prosthesis.

Yet another antecedent step may include capturing digital and/or physical impressions for the arch to be restored as well as for the opposing arch. Digital and physical impressions are created using conventional techniques known within the art.

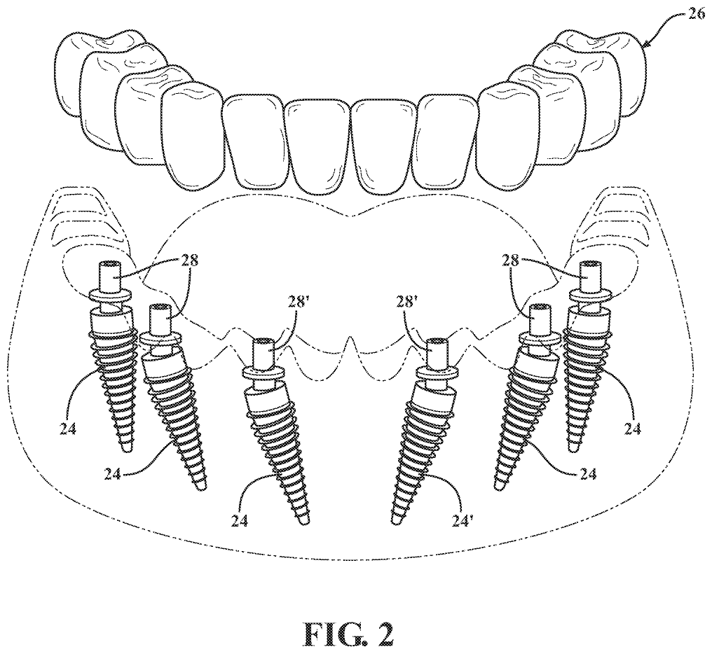

FIG. 2 depicts a dental prosthesis 26 in the exemplary form of a full arch restoration. Although the types of dental prostheses 26 can take many different forms, it is generally true that all can be categorized as a prosthetic appliance or device that is anchored into the mandible or maxilla, over an edentulous site, via the plurality of implants 24. In short, the dental prosthesis 26 is an implant supported fixed prosthetic device. A plurality of implants 24 being at least two in number, but in some cases four or five or six—whatever number is required by the circumstances. The example of FIG. 2 shows six implants 24 placed in the mandible, with the entirety of the mandible being edentulous; a lower full arch restoration. In other cases, only a fragmentary portion of the mandible or maxilla will be edentulous. As such, the two or more implants 24 are spaced apart from one another along the maxilla, or along the mandible as the case may be, in the edentulous area.

Each implant 24 has an internal connection configured to mechanically couple with a multi-unit abutment 28, as is well-known within the art. Although the implants 24 will be hidden from view due to their placement in the patient's mandible or maxilla, the multi-unit abutments 28 will be visible at several stages while carrying out the method of this invention.

The plurality of implants 24 includes first and second anterior implants 24′ located nearest the area designated for incisor teeth. In cases like those depicted in FIG. 2 where the edentulous site spans the incisor teeth area, the first and second anterior implants 24′ will generally be selected as the two most anterior implants 24. When the edentulous site does not span the incisor teeth region, the first and second anterior implants 24′ may be selected the two most anteriorly located implants 24. Naturally, in any case where the total number of implants 24 placed is only two, then the first and second anterior implants 24′ will be those two. But when the patient has three or more implants 24 placed, the first and second anterior implants 24′ will be the two implants 24 located nearest the area designated for incisor teeth. The multi-unit abutments 28 attached to the first and second anterior implants 24′ are designated first and second multi-unit abutments 28′ throughout the figures.

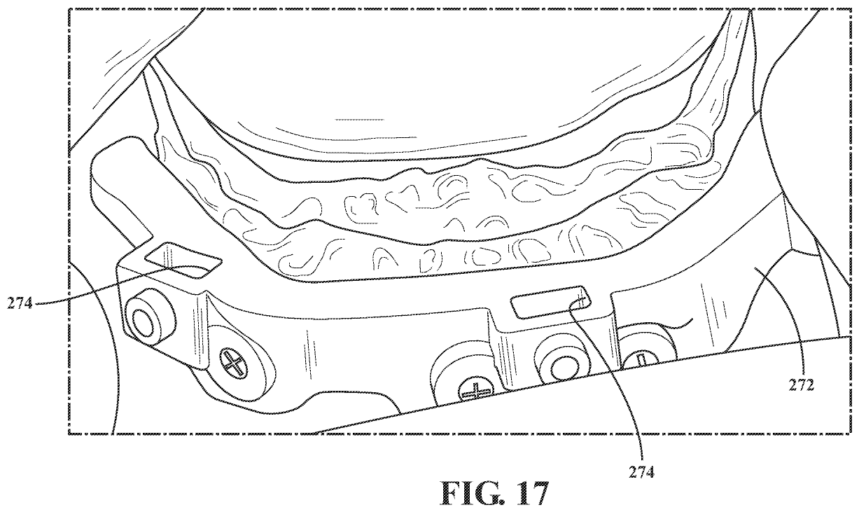

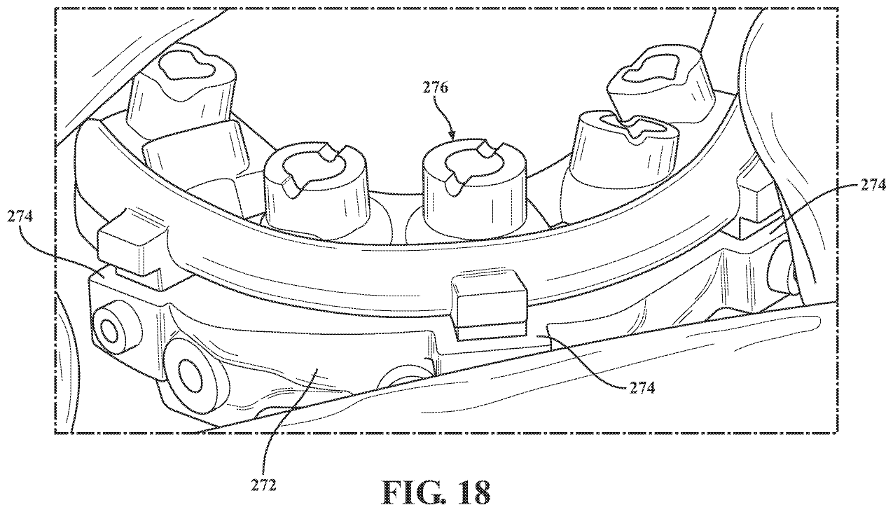

It should be mentioned that is some cases, the implants 24 may be placed using a relatively modern procedure known as guided surgery. In this technique, computer designed and manufactured precision surgical guides allow doctors to accurately place implants 24 safely, predictably and efficiently. The surgical guides are anchored in place over the edentulous site, sometimes with the aid of a bone foundation guide, establishing the precise location and angular orientation with which to create the osteotomy to receive the implant 24, and support the implant 24 as it is screwed into position. Thus the antecedent step of in vivo placing a plurality of dental implants 24 may include affixing a detachable bone foundation guide to the mandible or maxilla inside the patient's mouth in the area of the edentulous site (see FIG. 17), followed by the step of attaching a drilling guide to the bone foundation guide (see FIG. 18).

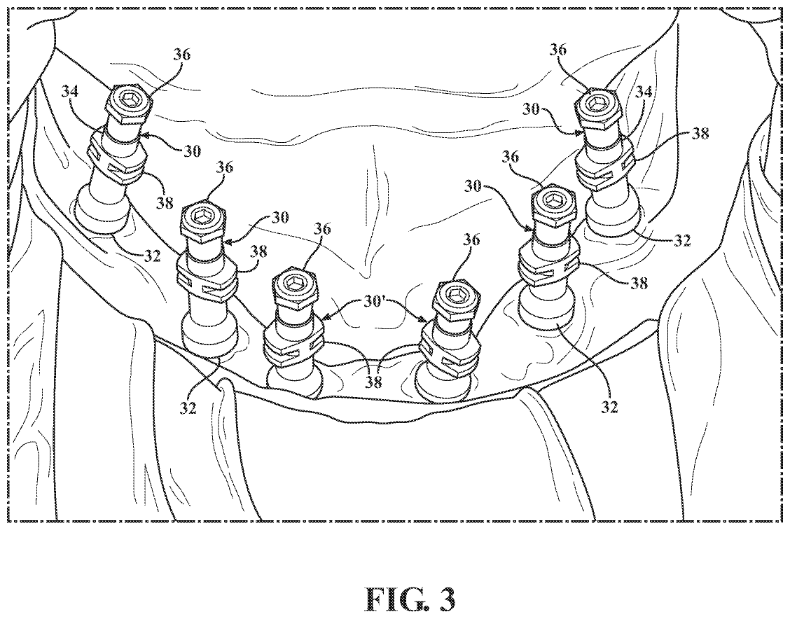

At a time appropriate after placing the implants 24, possibly same day, the method for determining the size and shape of a dental prosthesis 26 formally begins with the step of in vivo attaching a coping impression 30 to each implant 24. Because the implants 24 are laterally spaced apart, there will be a corresponding lateral space between each coping impression 30 and the next adjacent coping impression 30. The example of FIG. 3 carries somewhat but not exactly from the example of FIG. 2, in that six coping impressions 30 are attached respectively to six implants 24 in the mandible of a patient requiring a full arch restoration 26.

Each coping impression 30 comprises a generally tubular sleeve extending between a seated end 32 and an upstanding end 34. That is to say, the coping impressions 30 are hollow. The coping impressions 30 shown in the illustrations are of the standard open-try type, having mid-length locking grooves 38. The in vivo attaching step includes compressing the seated end 32 of each coping impression 30 against the associated multi-unit abutment 28. This is accomplished, typically, by inserting an elongated fastener 36 through the tubular sleeve of each coping impression 30 so that it engages with the multi-unit abutment 28 of the associated implant 24. In most cases, the elongated fastener 38 comprises a screw, however other fastening schemes may be possible. The overall shape of the coping impression 30, and in particular its locking groove 38, can vary widely among different manufacturing sources. Those illustrated in the accompanying Figures are merely exemplary.

It will be helpful to identify the coping impressions 30 attached to the first and second anterior implants 24′ (via the first and second multi-unit abutments 28′) as first and second anterior coping impressions 30′. As with the first and second anterior implants 24′, the first and second anterior coping impressions 30′ will typically be selected as the two coping impressions 30 located nearest the area designated for incisor teeth.

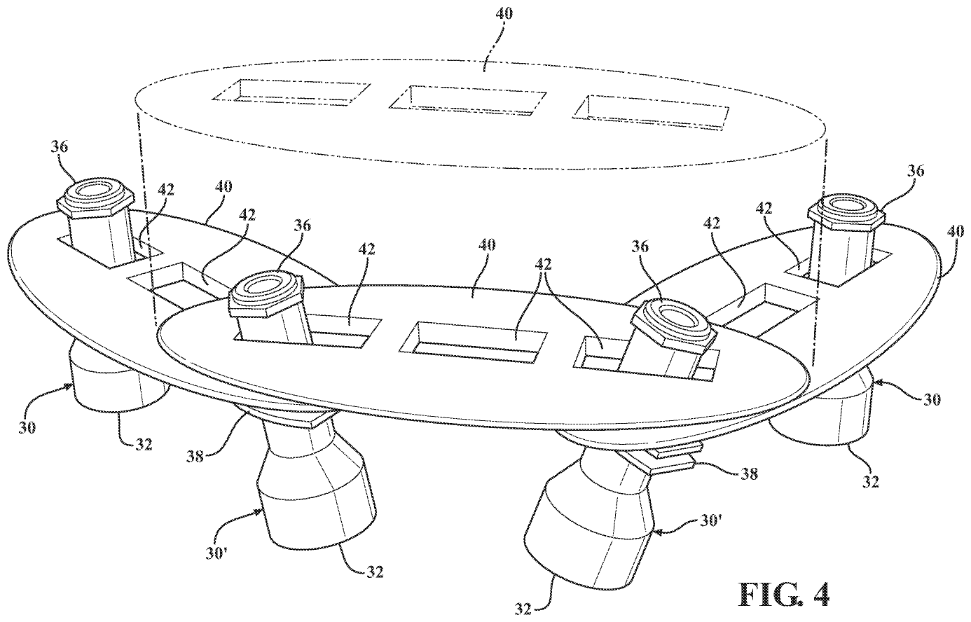

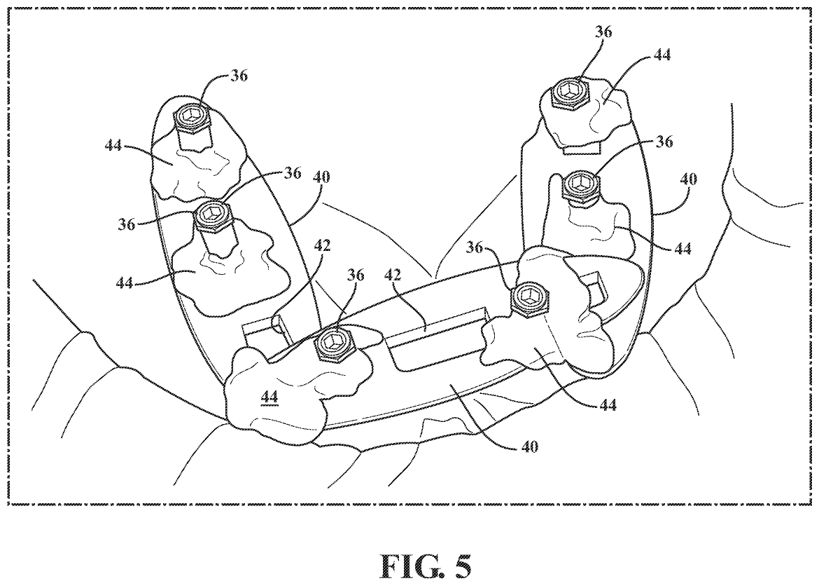

Turning now to FIGS. 4 and 5, the method continues with the step of creating a bite impression. There are several alternative methods to create a bite impression. One exemplary method includes in vivo spanning the lateral space between each coping impression 30 and the next adjacent coping impression 30 with one or more connector plates 40. The one or more connector plates 40 may be positioned between the locking groove 38 and upstanding end 34 of each associated coping impression 30, or if space is an issue then below the locking groove 38. In the simplified view of FIG. 4, each connector plate 40 encircles at least one coping impression 30 at a location that is between its locking groove 38 and upstanding end 34. However, as mentioned, there may be instances where the connector plate 40 is fitted below the locking groove(s) 38. In either case, the one or more connector plates 40 are suspended above the edentulous site, creating a narrow gap between the tissue surface of the edentulous site and the connector plates 40.

Naturally, if a particular patient has placed only two implants 24, only one connector plate 40 is needed. However, when more than two implants 24 are placed over an edentulous site that curves around the jawline, it may be advisable to utilize a plurality of connector plates 40 as shown in FIGS. 4 and 5. The number and arrangement of connector plates 40 to be seated over the coping impressions is determined by the practitioner to ensure desired proximity. In such cases, adjacent connector plates 40 will preferably overlap one another thus forming a stepped system or daisy-chain like network connecting all of the coping impressions 30. FIG. 4 shows adjacent connector plates 40 overlapping one another over common coping impressions 30. FIG. 5, on the other hand, shows adjacent connector plates 40 overlapping one another at extensions that do not contain a common coping impression 30. Both scenarios are well within the scope of this invention.

The connector plate 40 can take many different forms. The illustrated examples show an embodiment having a smoothly elliptical shape devoid of sharp edges or protruding corners, somewhat suggestive of a cigar or American football, which has the advantage of patient comfort. Other shapes are of course possible, including but not limited to ovals and crescents and J-shapes and C-shapes to name but a few. The connector plate 40 has a relatively thin body generally corresponding to the length of about three posterior teeth. Other contemplated sizes (not shown) correspond in length to the size of about two posterior teeth, and another in length to the size of about four posterior teeth. Regardless of length, the width of the Connector plate 40 is about equal to the width of a molar tooth. The thickness of the connector plate 40, regardless of length, is typically consistent at between about 0.5-5 mm, with about 2 mm considered generally adequate, however variations in the thickness are certainly possible.

A plurality of apertures 42, show in the form of slots, are formed in the body of the connector plate 40 so as to receive the upstanding end 34 of a coping impression 30 with an interference (or near interference) fit. In the illustrated examples where the length of the connector plate 40 generally corresponds to the length of three molars, three apertures 42 are provided to receive up to three impression copings 30. However, the number and size of the apertures 42, as well as the shape of the apertures, can be modified. For instance, instead of three apertures 42, there could be only one or two, or perhaps four or more.

The purpose of the interference fit is to provide some degree of stability when the connector plate 40 is fitted to a coping impression 30. The apertures 42 can easily slip over multiple coping impressions 30 and are easily adjusted chairside. The location of the pre-formed apertures 42 is meant to anticipate the location of the impression copings 30, which may or may not coincide with the actual positions of the coping impressions 30 in any given application. Where an impression coping 30 does not adequately align with any pre-formed apertures 42, the surgeon is required to modify the aperture 42 shape to receive the outlier coping impression 30. Likewise when it is necessary to locate the connector plate 40 below a locking groove 38, the aperture 42 may need to be modified.

Instead of the pre-formed apertures 42 having a rectangular shape, the connector plates 40 could instead be configured with slits or ovals, or flaps of straight or zigzag or crenulated form, or any other suitable shape capable of receiving the upstanding ends 34 of the coping impressions 30. In another contemplated example, the connector plates 40 could be fabricated from a composite material having a rigid frame supporting a resilient body through which the coping impressions 30 extend.

Although the figures depict the connector plate 40 having pre-formed apertures 42, it is also contemplated that the connector plate 40 could be configured without any predefined/pre-formed apertures. In this case, the connector plate 40 could be a solid body and the surgeon will custom drill holes to receive each coping impression 30. Indeed, many alternatives are possible.

The illustrated examples show an embodiment made of a semi-rigid polymeric material, more specifically a 3-D printed resin. Preferably, the connector plate 40 is fabricated from a rigid biocompatible 3D printed or milled resin capable of holding its shape and easy to adjust by drilling or adding more light-cured resin. This firm rigid connection allows further verification of the accuracy and prevents errors. Preferably, the selected material properties of the connector plates 40 will allow for easy adjustment chairside and effective luting together with pattern resin.

Turning now to FIG. 5, the next step in the method comprises in vivo bonding each connector plate 40 to the associated upstanding ends 34 of the coping impressions 30. The in vivo bonding step includes applying a curable bonding resin 44 at the juncture of each coping impression 30 with the connector plate 40. The bonding resin 44 can be any suitable compound of the type known and used by dental practitioners, such as a light-cure pattern resin. The use of light-cure resin in place of traditional cold-cure GC resin further reduces the chair time required. The purpose of the bonding resin 44 is to increase substantially the degree of stability and rigidity of the connection between the connector plates 40 and the coping impressions 30, forming same into a monolithic structure.

Connector plates 40 replace the traditional process of tying sturdy twine (dental floss) around all copings and meticulously applying slow-setting GC resin over the floss base using a salt-and-pepper application. The intraoral placement of floss around the coping impressions can be problematic, extending chair time. In contrast, the connector plates 40 can be prepared ex vivo, either in advance or chairside (on demand) and are therefore substantially more efficient.

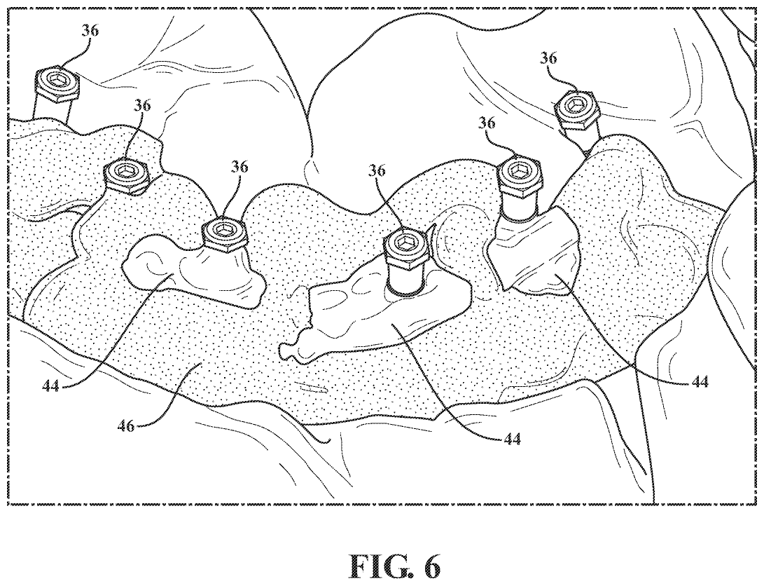

After the bonding resin 44 has sufficiently solidified, the method continues with the step of in vivo embedding the connector plates 40 together with the coping impressions 30 and the bonding resin 44 within a curable impression material 46, as shown in FIG. 6. Effectively, a tray-less impression is performed. The curable impression material 46 can, for example, be a polyvinyl siloxane putty and light-body wash used to encase the jig structure without the use of an impression tray. This in vivo embedding step includes filling the gap below the connector plates 40 with the viscous impression material 46 so that the impression material 46 completely overlays the edentulous site. Some significant quantity of the impression material 46 is also directed over the connector plates 40 while in its viscous form. The polyvinylsiloxane putty consistency is adapted from the palatal or lingual side to provide support. From the vestibular side the light consistency of the polyvinylsiloxane is applied. Care is taken to avoid covering the upstanding ends 34 of the coping impressions 30 so as to maintain access to the fasteners 36.

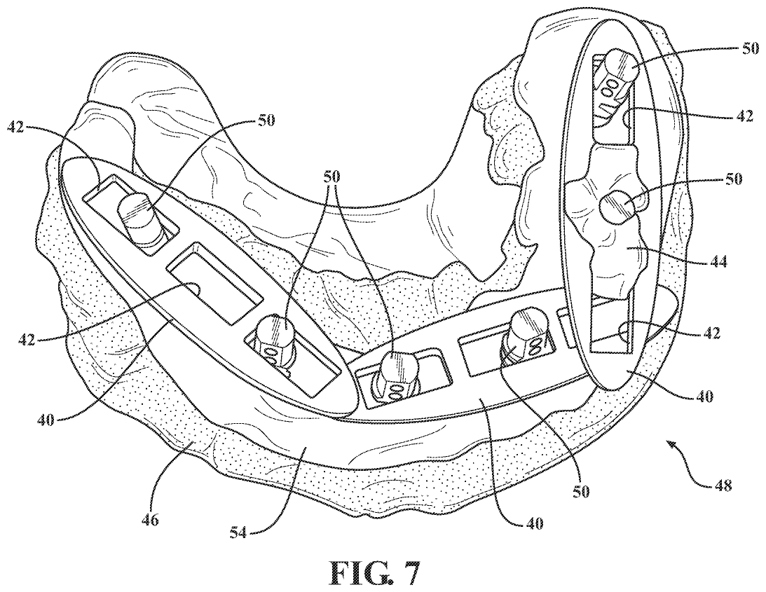

Once sufficient coverage has been achieved, the impression material 46 is allowed to solidify into a rigid monolithic bite impression 48 (FIGS. 7 & 8) that contains the connector plates 40 and coping impressions 30. The bite impression 48 retains the exact, albeit negative, topography of the edentulous site, including implant positions and soft tissues. The bonded and embedded connector plates 40 help maintain the coping impressions 30 in the exact orientations needed to attach with the implants 24.

The method continues with the step of creating a physical model from the bite impression. There are several alternative methods to create a physical model. In the illustrated examples, as a next step, the bite impression 48 is relocated from in vivo to ex vivo. The relocating step requires disconnecting each elongated fastener 36 from the multi-unit abutment 28 of the associated implant 24 so that the bite impression 48 can be disassociated from the patient. Upon removing the bite impression 48 from the patient's mouth, the negative impression of the edentulous site will be observed. The negative impression of the edentulous site will also expose the seated ends 32 of each coping impression 30, a condition easily imagined by those skilled in the art.

FIG. 7 shows the bite impression 48 ex vivo, as if upside down set upon a worktable. From the perspective of FIG. 7, the upstanding ends 34 of the coping impressions 30 are not visible, pointing down and possibly resting against the surface of the worktable. In this ex vivo condition, a lab analogue 50 can be connected to the exposed seated end 32 of each coping impression 30. The lab analogues 50 serve as surrogates or proxies for the multi-unit abutments 28 with their respective implants 24. Each lab analogue 50 is thus a receiving socket configured to mechanically couple with a removeable fastener 36. The ex vivo connecting step includes inserting an elongated fastener 36 through the tubular sleeve of each coping impression 30 into engagement with the associated lab analogue 50. As previously mentioned, the elongated fasteners 36 can be screws or some other form of connector.

Note that the lab analogues 50 attached to the first and second anterior coping impressions 30′ comprise first and second anterior lab analogues 50′. As with the first and second anterior implants 24′ and the first and second anterior coping impressions 30′, the first and second anterior lab analogues 50′ are the two lab analogues 50 located nearest the area designated for incisor teeth.

Once the lab analogues 50 are securely attached to the bite impression 48 via the corresponding coping impressions 30, the method continues by ex vivo casting a physical model 52 from the bite impression 48. The ex vivo casting step includes applying a thin layer of soft tissue replica before encasing the lab analogues 50 in a curable compound 54. The soft tissue material can be injected around the exposed portion of each lab analog 50 and the surface of the bite impression 48 to create the soft tissue replica.

Optionally, connector plates 40 can be added to the lab analogues 50 in much the same way as was done the coping impressions 30, as shown in FIG. 7. Connector plates 40 serve to add stability to lab analogues 50 cast within the completed physical model 52, thus reducing chances of distortion resulting from warpage or rough handling. The connector plates 48 can be bonded to the lab analogues 50 with bonding resin 44 in the same manner as previously described and/or simply encased in the curable compound 54.

In its viscous state, a curable compound 54 flows over the soft tissue replica layer and the connector plates 40. In this example, the curable compound 54 is a dual cure resin material, as the setting time of this material is a fraction of that of traditional model stone. The entire process of creating the physical model 52, from the removal of the bite impression 48 from the mouth to the complete setting can be achieved in as little as 20 minutes.

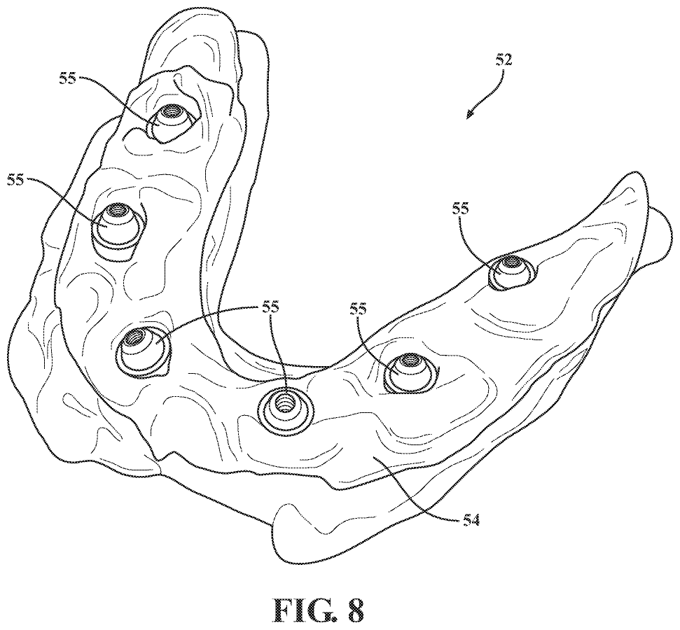

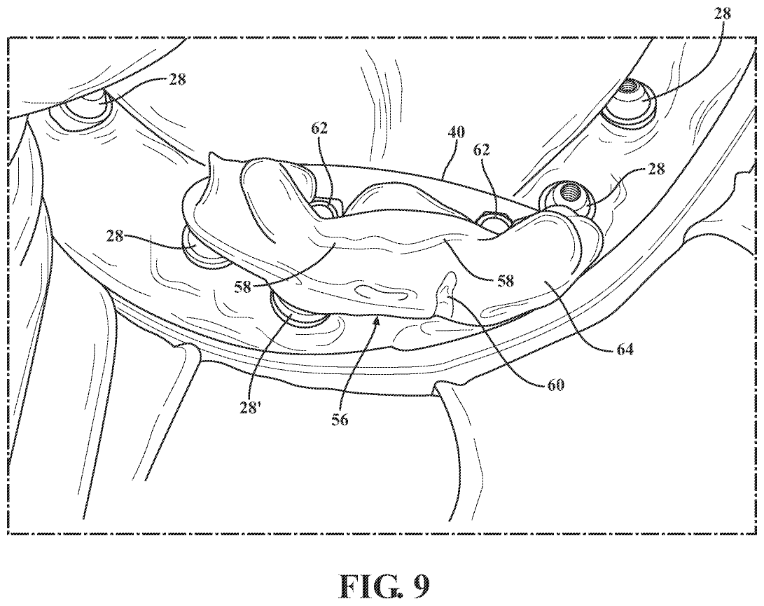

When the physical model 52 is fully completed, the fasteners 36 are removed, allowing the bite impression 48 to be separated away from the physical model 52. The finished physical model 52 provides an accurate record of implant 24 positions and soft tissues and requires minimal fabrication time before use. FIG. 8 shows the physical model 52 after it has been separated from the bite impression 48. Exposed ends 55 of the lab analogues 50 visible in FIG. 8 reveal the threaded sockets configured to receive the fasteners 36. The exposed ends 55 of the lab analogues 50 replicate ex vivo the in vivo multi-unit abutments 28. When compared to the in vivo view of FIG. 9, it can be observed that the placement of the exposed ends 55 of the lab analogues 50 exactly matches those of the actual multi-unit abutments 28.

To reiterate, the physical model 52 comprises a generally exact scale replica of the edentulous site with each encased lab analogue 50 corresponding in relative location and orientation with a respective one of the dental implants 24. As with the first and second anterior implants 24′ and the first and second anterior coping impressions 30′, the first and second anterior lab analogues 50′ are the two lab analogues 50 located nearest the area designated for incisor teeth. The physical model 52 has the first anterior lab analogue 50′ corresponding in relative location and orientation to the first anterior implant 24′ and the second anterior lab analogue 50′ corresponding in relative location and orientation to the second anterior implant 24′. The first and second anterior lab analogues 50′ have exposed ends 55′.

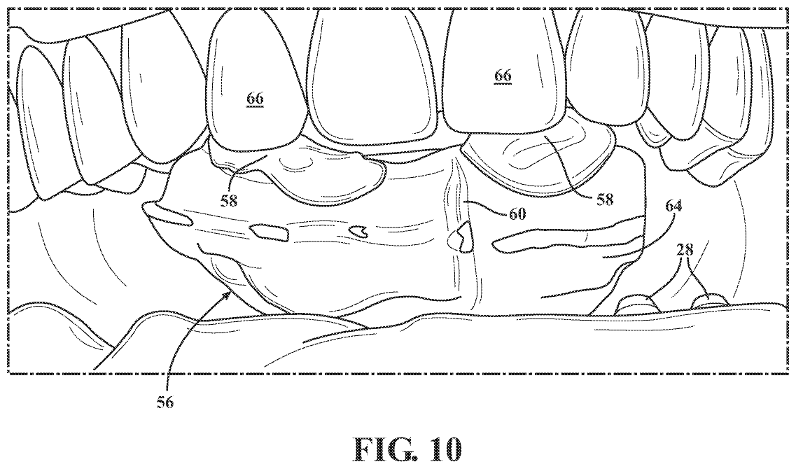

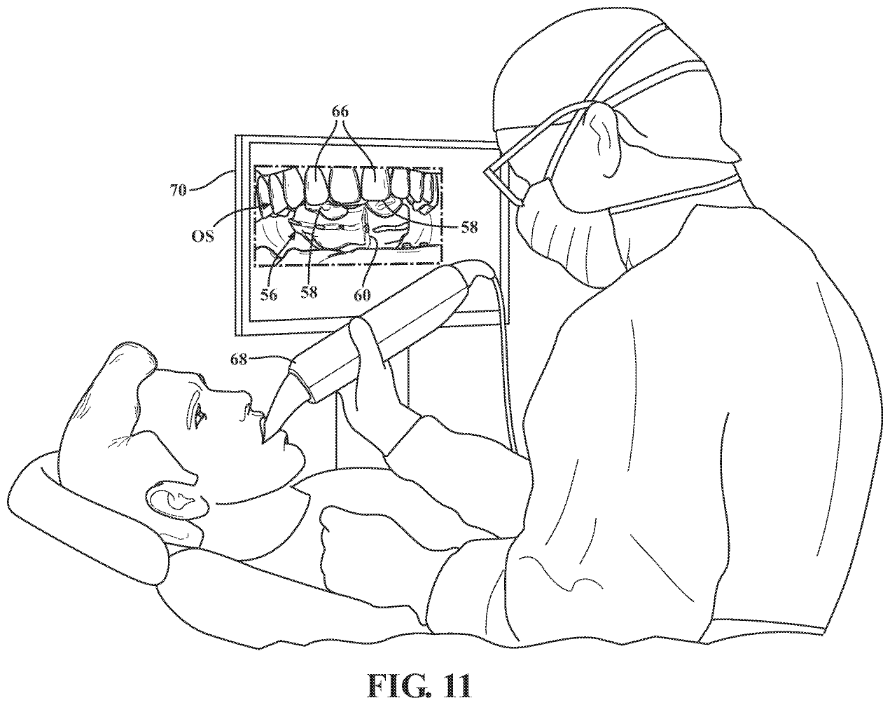

With the physical model 52 safely set aside but near to the patient, the method continues with the step of in vivo attaching an anterior scanning device 56, or ASD for short, to the first and second anterior multi-unit abutments 28′. See FIGS. 9 and 10. The ASD 56 is a novel approach to precisely document the jaw relationship, vertical dimension of occlusion (VDO), and midline of the patient while seamlessly combining data from both intraoral (in vivo) and extraoral (ex vivo) digital scans. The ASD 56 is necessarily custom-made for each patient, and serves as a stable reference point in the anterior section of the patient's oral cavity, facilitating consistent occlusion and VDO, midline recording, and easy transfer to and from the physical model 52, which will be described subsequently.

Thus, the ASD 56 can be understood as a tool for reconstructing, documenting and transferring the patient's vertical dimension of the occlusion (VDO), midline and/or bite details. The transferring referenced here is from in vivo to ex vivo as will be described. The vertical dimension of occlusion (VDO) may be understood as the lower facial height measured between two points when the maxillary and mandibular teeth are intercuspated. That is to say, the VDO establishes the proper vertical position of the mandible in relation to maxilla looking forward to the time when the patient will have occluding members in contact. The ASD 56 has at least one surface configuration that is a scannable marker capable of indicating a vertical dimension of occlusion (VDO), midline and/or bite details. In the example of FIGS. 9 and 10, the ASD 56 includes VDO marker 58 which also serves to provide scannable marker for bite details, and midline marker 60.

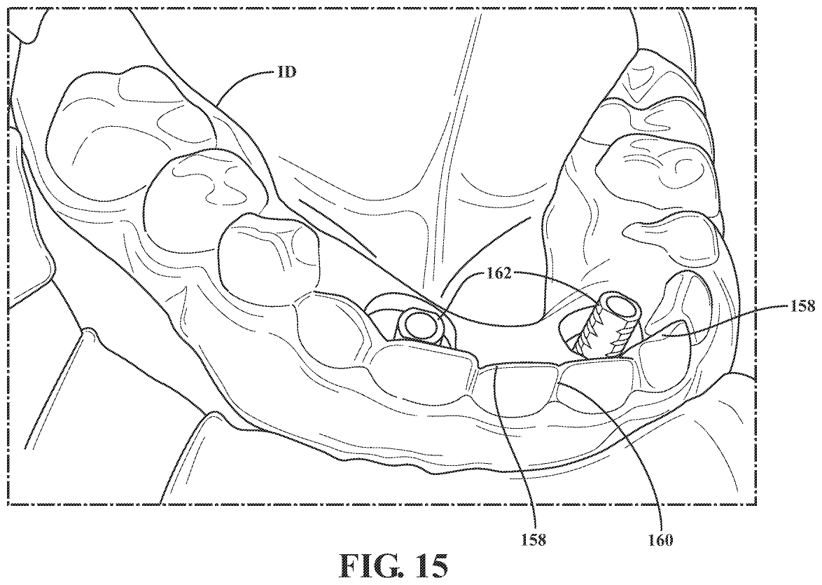

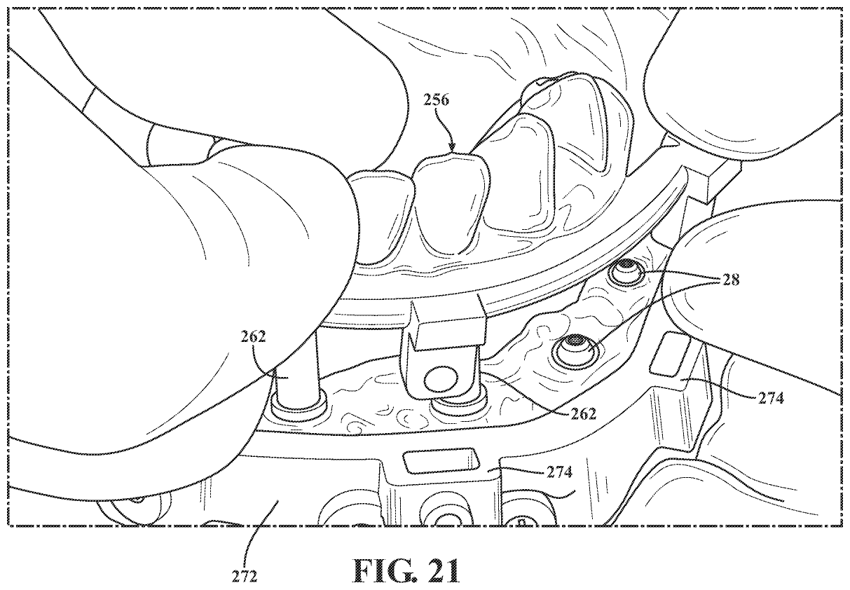

FIGS. 9 and 10 illustrate one way of creating the ASD 56. The step of in vivo attaching an ASD 56 includes attaching a first cylinder 62 to the first anterior multi-unit abutment 28′ and a second cylinder 62 to the second anterior multi-unit abutment 28′. The first and second cylinders 62 are mostly covered in FIG. 9 and not at all visible in FIG. 10. However, the cylinders 62 can be easily seen in FIGS. 15 and 21, which describe alternate methods of creating the ASD 56. The first and second cylinders 62 are similar in some respects to the coping impressions 30, in that they are sturdy tubular constructions that are attached to the first and second anterior implants 24′ via their respective multi-unit abutments 28′ using threaded fasteners similar to the fasteners 36 described previously.

Next, the cylinders 62 are monolithically encased in a hardening resin compound 64. Optionally, a connector plate 40 (FIG. 9) can be placed over the cylinders 62 as a quick and easy means to increase stability. The hardening resin compound 64 can be of any suitable composition known and used in the art capable of being built-up in an upstanding wad between and around the cylinders 62. In practice, it is likely necessary to build-up the wad in stages or increments until the lower facial height is properly established by occluding members in direct contact with resin wad. That is, supplemental hardening resin compound 64 may be incrementally added, as and if needed, to reconstruct the vertical dimension of the occlusion. The repeatable bite in centric relation is recommended.

This incremental addition of hardening resin compound 64 can be observed in FIG. 10, where the patient's occluding teeth 66 make contact with and leave slight impressions in a built-up crown of uncured resin compound 64. These impressions are surface configurations representing scannable features that comprise the VDO markers 58 and also provide scannable details concerning the bite. In the illustrated example a single subsequent application of hardening resin compound 64 was needed to achieve sufficient height of the wad so that the VDO markers 58 could be properly established. In other cases multiple subsequent additions may be needed, or perhaps none at all if the initial encasement of the cylinders 62 produces a wad of sufficient height to capture the necessary VDO markers 58.

Either before or after the VDO marker 58 is established, and while the hardening resin compound 64 remains malleable, the midline marker 60 is placed on the wad. The midline marker 60 is a surface configuration scannable feature that coincides with (or at least approximates) the anatomical midline of the patient and must therefore be custom established. The midline marker 60 can take many different forms. In the example of FIGS. 9 and 10, the midline marker 60 can be seen as a vertical groove on the forward-facing portion of the completed ASD 56.

Once the anterior scanning device 56 has been fully constructed within the oral cavity, the scanning procedure commences to gather all the essential digital data required for provisional design. The process unfolds in the following steps:

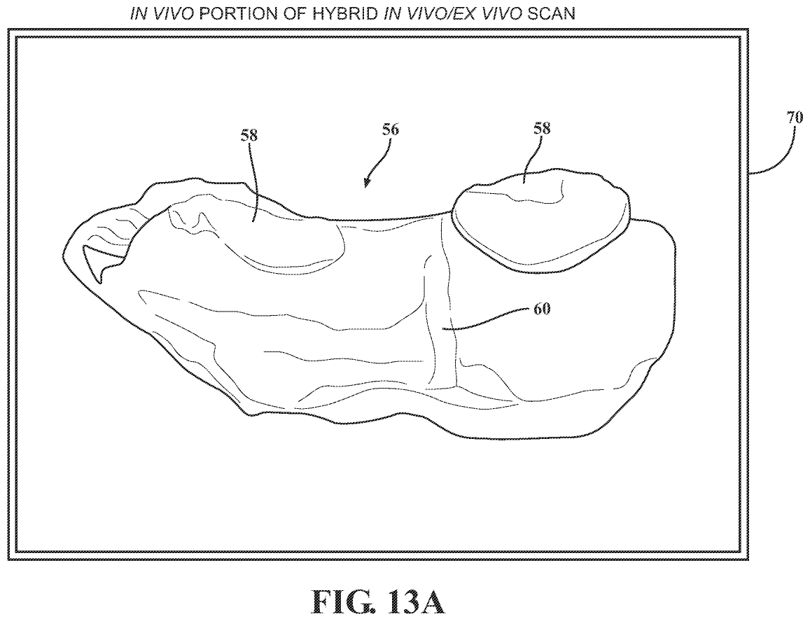

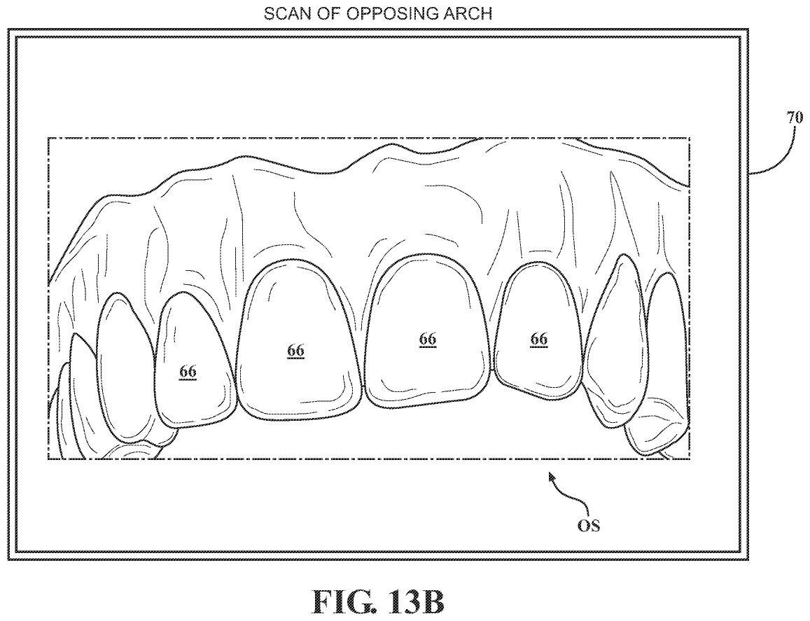

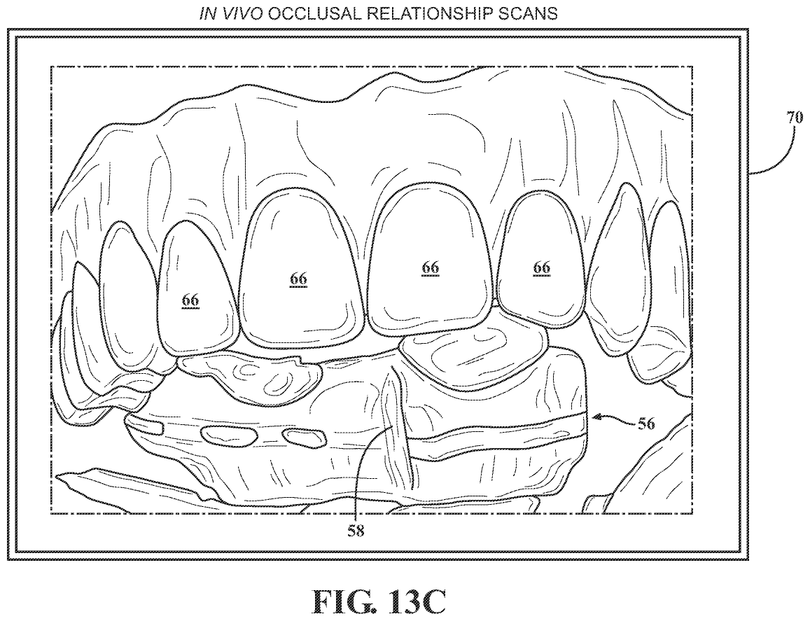

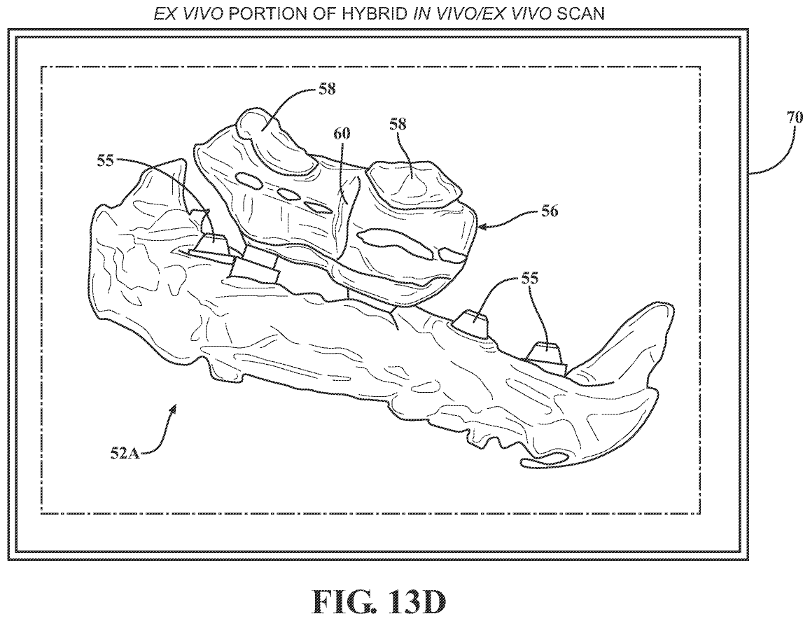

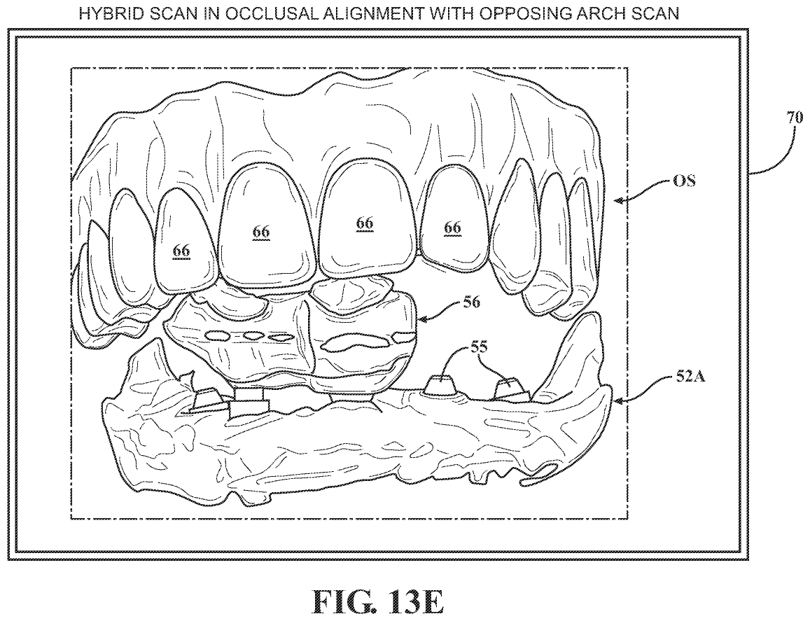

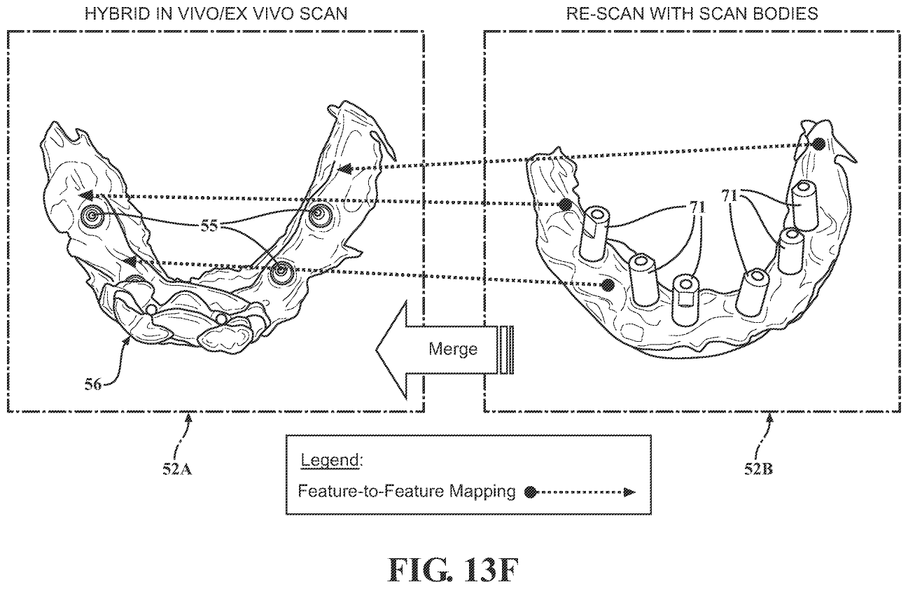

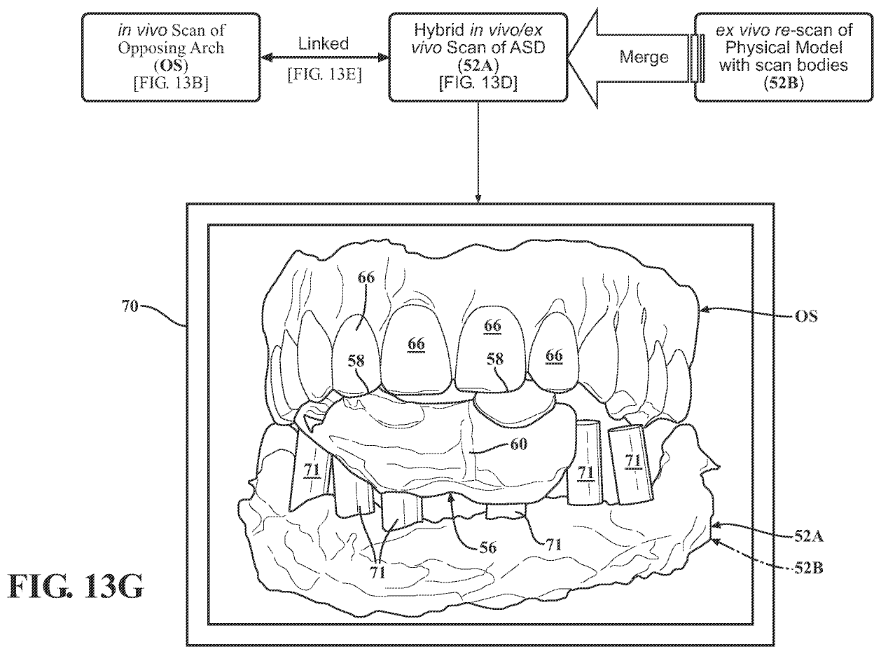

Using an intra-oral scanner 68, an in vivo digital scan is made of the patient's opposing arch. Throughout the remaining discussion, the opposing arch scan and/or its graphical depiction is identified by the reference number OS. FIG. 13B is an image on a display screen 70 graphically representing or projecting the digital file within which is contained the 3D scan of the opposing arch OS. This step results in the creation of a first STL file.

While the ASD 56 remains secured in vivo to the lower arch in this example, the method progresses to the next step, which is creating a hybrid in vivo/ex vivo digital scan of the arch that has the implants using (preferably) the same intraoral scanner 68. Throughout the remaining discussion, the hybrid in vivo/ex vivo digital scan and/or its graphical depiction is identified by the reference number 52A. The step of creating a hybrid in vivo/ex vivo digital scan 52A begins with an in vivo scan that captures the intra-oral portion of the hybrid digital model, focusing on the ASD 56 while minimizing surrounding tissue. This stage yields the in vivo portion of the hybrid scan 52A, which portion covers the anterior part (the ASD 56 to be specific) of a second STL file recording. FIG. 13A is an image on the screen 70 graphically representing or projecting the digital file within which is contained a 3D scan of the ASD 56, which is the in vivo portion of the hybrid scan 52A.

Those of skill in the art will appreciate that the step of in vivo digitally recording the ASD 56 typically includes hand-manipulating the intraoral scanner 68, although mechanized systems could be imagined. FIG. 11 shows an exemplary representation of a hand-held intraoral scanner 68 that outputs a graphic representation of the topographical contours inside the patient's mouth to a display screen 70. The images seen on the screen 70 are merely a graphical representation or projection of one or more digital files; the actual digital file (or files), typically in STL format, is stored in a non-transitory computer readable medium coded with instructions and executed by a processor to perform the scanning-related steps which include displaying the image on a screen 70.

Once the in vivo portion of the hybrid scan 52A is completed (FIG. 13A), the patient is prompted to close their bite so that their occluding teeth 66 come in contact with the VDO markers 58 on the ASD 56. In an in vivo (intra-oral) scan, the bite is captured digitally, signifying the relationship or alignment between the in vivo portion of the hybrid scan 52A and the opposing arch scan OS. FIG. 13C is a display image on the screen 70 graphically representing or projecting the two distinct digital files—the opposing arch scan OS and the in vivo portion of the as-yet uncompleted hybrid scan 52A—within which is contained the in vivo relationship scan. That is to say, although the scan of the opposing arch OS is a separate scan typically recorded as a separate STL file, most commercially available software will enable the in vivo opposing arch scan OS to be directly mapped to the in vivo digital recording of the ASD 56 if conducted in sequence with one another with the necessary software commands being initiated at the time.

The step of in vivo digitally recording the ASD 56 inside the patient's mouth does not include scanning the edentulous site because of the inherent unreliability of any readings taken caused by blood and other fluids. The step of in vivo digitally recording the ASD 56 is not to be confused with any digital scanning that may have been accomplished during the pre-surgical planning phase that would not have included the ASD 56. The step of in vivo digitally recording the ASD 56 includes being careful to capture its VDO marker 58 and/or midline marker 60.

For convenience, the screen 70 images in FIG. 11 corresponding to the ASD 56 are identified with reference numbers to show the VDO marker 58 and midline marker 60 captured in vivo in the digital file by the intraoral scanner 68. The linked scan of the opposing arch OS is also visible in the screen 70, in bite relationship with the in vivo scan data of the ASD 56. At this point, the in vivo portion of the hybrid digital scanning session is completed. In the preferred embodiment the digital scanning session is simply paused, such that the STL file to which the digital scan is being recorded remains open and active pending the accumulation of further scanning information. However, if the practitioner were to terminate scanning application for some reason, a partial hybrid digital STL file is saved for later completion.

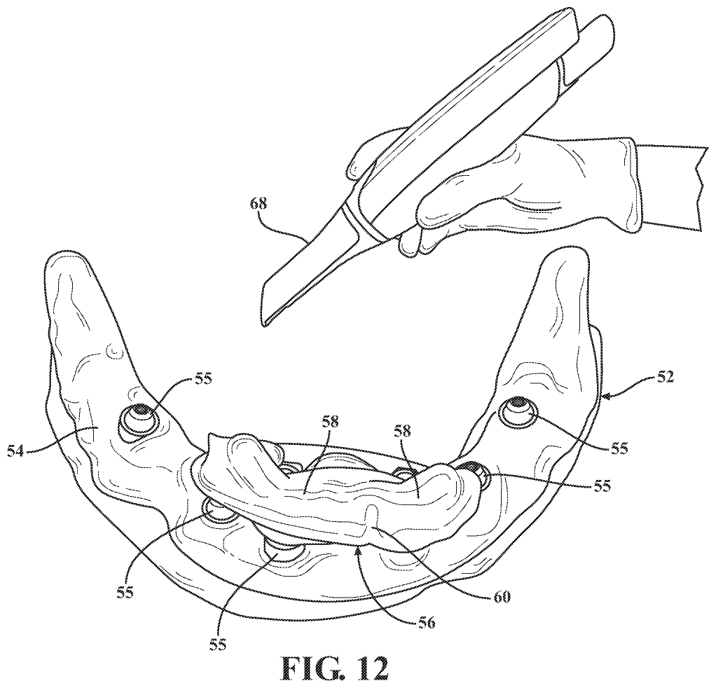

Continuing, the step of creating a hybrid in vivo/ex vivo digital scan 52A further includes detaching the ASD 56 from the first and second anterior implants 24′. This is accomplished by removing the fasteners 36 that pass through the cylinders 62. The ASD 56 is then dislocated from the patient's mouth, transferred to the ex vivo physical model 52 where it is attached to the corresponding first and second anterior exposed ends 55′ of the lab analogues 50′. The ASD 56 is installed on the physical model 52 in preparation for continuation of the ASD scanning in an ex vivo environment, as shown in FIG. 12. Preferably, the physical model 52 is located on a work surface in close proximity to the intraoral scanner 68. Using suitable fasteners 36, the ASD 56 is attached to the first and second anterior lab analogues 50′ encased within the physical model 52. In other words, the ASD 56 is transferred, or relocated, from intraoral attachment to the physical model 52—from in vivo to ex vivo.

The step of creating a hybrid in vivo/ex vivo digital scan 52A is concluded by ex vivo scanning the physical model 52 with attached ASD 56. Most commercially available intraoral scanners 68 marketed to the dental community allow for editing, continuation, or deletion of any scanning step at any point. Therefore, after transferring the ASD 56 from in vivo (intra-oral) to ex vivo (physical model 52), the STL file containing the in vivo portion of the as-yet uncompleted hybrid scan 52A is awakened or reopened to resume the scanning process and finally complete the hybrid scan 52A. By using the same intraoral scanner 68 and merely unpausing or re-activating the previous in vivo STL file, a continuous blending of the newer ex vivo scan data with the previous in vivo scan data results. Given that scanning technology by its very nature relies on a stitching feature that continuously overlaps images to generate a digital 3D file, as soon as the software fed by the scanner 68 detects the ASD 56 in the ex vivo environment, the scanner 68 proceeds with the scanning process not realizing there has been a shift from in vivo to ex vivo. The scanner 68 immediately recognizes the ASD 56, albeit in an ex vivo setting, and then simply continues the existing scanning session by encompassing the physical model 52 along with its representation of soft tissue. The practitioner takes care to scan other parts of the physical model 52, such as its representations of soft tissue and the exposed ends 55, which represent the multi-unit abutments 28. Advantageously, the intraoral scanner 68 does not distinguish that the scanning process started inside the mouth has now moved to the ex vivo physical model 52 where the recording process resumes following the previously mentioned pause.

Since the bite, orientation, or alignment was captured while the ASD 56 was intra-oral, the ex vivo (extra-oral) portion of the hybrid digital scan 52A aligns accurately with the opposing arch scan OS precisely because the scanning software does not realize that the ASD 56 has been transferred to a model 52. The twice-scanned ASD 56 provides common reference information about the occlusion, VDO, and midline. The extraoral scan of the physical model 52 with attached ASD 56 enables increased accuracy because it is not constrained by the confined intraoral working spaces, fluids, poor lighting, soft tissue or patient comfort.

The hybrid in vivo/ex vivo digital scan 52A is completed after the extraoral scan of the physical model 52 with attached ASD 56. Thus, the hybrid in vivo/ex vivo digital scan 52A is composed of an in vivo portion and an ex vivo portion knitted or stitched together through the ASD 56. The value of the in vivo portion lies in its capture of the bite (FIG. 13C), whereas the value of the ex vivo portion lies in its capture of the proper orientation of the accurate model. The hybrid scan 52A (in this example the lower arch) is one STL file and the opposing arch scan OS (in this example the upper arch) is another STL file, but the two STL files are linked to one another through the software through the bite information captured during the in vivo portion of the hybrid scan 52A (FIG. 13C). These two STL files—OS and 52A—mirror the patient's vertical dimension of occlusion precisely.

FIG. 13E shows the linked in vivo scan of opposing arch (FIG. 13B) with the hybrid in vivo/ex vivo digital scan of FIG. 13D, enabling the hybrid in vivo/ex vivo digital scan 52A to be viewed in occlusal alignment (relationship) with the in vivo scan of the opposing arch OS.

Once the hybrid in vivo/ex vivo digital scan 52A is completed, the practitioner removes the ASD 56 from the physical model 52. The ASD 56 has concluded its service and is no longer needed. Scan bodies 71 are attached to the exposed ends 55 of the lab analogues 50. The scan bodies 71 are of known dimensions and serve as scannable indicators for showing both location and angular orientation of the lab analogues 50, which in turn allow the location and angular orientation of the actual implants 24 to be precisely computed in a digital environment. Digital representations of the scan bodies 71 are shown in FIGS. 13F and 13G.

The intraoral scanner 68 can be any suitable product of the type commercially available and sufficiently suited to the task. The intraoral scanner 68 may have the capability to provide multiple scans for the same arch as a biocopy or additional scan, a feature that can be used to collect more data for the same arch.

With the scan bodies 71 attached to each respective lab analogue 50, an ex vivo re-scan of the physical model 52 is made, this time without the ASD 56 blocking the anterior portion of the edentulous site. Throughout the remaining discussion, the ex vivo re-scan of the physical model 52 sans ASD 56 and/or its graphical depiction is identified by the reference number 52B. See right-hand image on FIG. 13F. Those of skill in the art will appreciate that when the ASD 56 is attached to the physical model 52, it obscures the underlying first and second exposed ends 55′, as well as some portion of the surrounding soft tissue. By removing the ASD 56, clearance is provided to attach scan bodies 71 to all lab analogues 50, including the first and second lab analogues 50′.

The step of ex vivo re-scanning the physical model 52 can be accomplished using the same intraoral scanner 68 or a different intraoral scanner. However, there are advantages to using a desktop scanning device of the type commonly found in dental labs. A desktop scanning device is not intended for use intraorally. By ex vivo re-scanning the physical model 52 with a desktop dental scanner 68, it may be possible to obtain higher resolution images. To summarize, the ASD 56 is removed from the physical model 52 so that lab scan bodies 71 can be installed and connected to the lab analogues 50 of the physical model 52. Following this, the physical model 52 is re-scanned with the scan bodies 71 attached and the scan data is saved to a digital file 52B.

By this stage, digital scan data has been accumulated: 1) an in vivo scan OS of the opposing arch (FIG. 13B); 2) a hybrid in vivo/ex vivo scan 52A capturing bite details and some surrounding soft tissue and multi-unit abutment data from the physical model 52 (FIGS. 13C and 13D); and 3) a re-scan 52B of the physical model 52 with scan bodies 71 connected to the lab analogues 50 representing accurate implant position and soft tissue information.

To increase the value of the 3D model, the hyper-precise ex vivo physical model scan 52B is merged with the hybrid scan 52A, yielding extremely accurate scan data to be observed in accurate occlusion without the need for external mounting of models. As depicted in FIG. 13F, the re-scan 52B is merged or mapped to the hybrid scan 52A by correlating at least three (3) points of commonality. This merging, or stitching, of the re-scan digital file 52B to the hybrid scan digital file 52A can occur seamlessly using commercially available computer software designed to precisely align and overlay the several scans. The ex vivo re-scan 52B completed with scan bodies 71 in place fills in the information about implant position with elevated scan accuracy and details of soft tissue. Combined, the accumulated digital scan data from in vivo and ex vivo source OS, 52A and 52B produces a remarkably accurate record of all essential details required for precise and ideal restoration of the edentulous arch.

FIG. 13G shows the three distinct scan files (opposing arch OS, hybrid 52A and re-scan 52B) being used to create a highly accurate digital representation of the patient's mouth with teeth in occlusion superimposing the ASD 56 and scan bodies 71. The resulting graphic of FIG. 13G provides the practitioner with all information needed to design (CAD), fabricate and stain a prosthesis 26. It is expected that the practitioner or a skilled technician could, if desired, analyze the graphic depiction of FIG. 13G, and carefully manipulate the surface shapes to perfect the data set. The result is useful, detail-rich digital data that is then used to fabricate a dental prosthesis 26 according to the collated data.

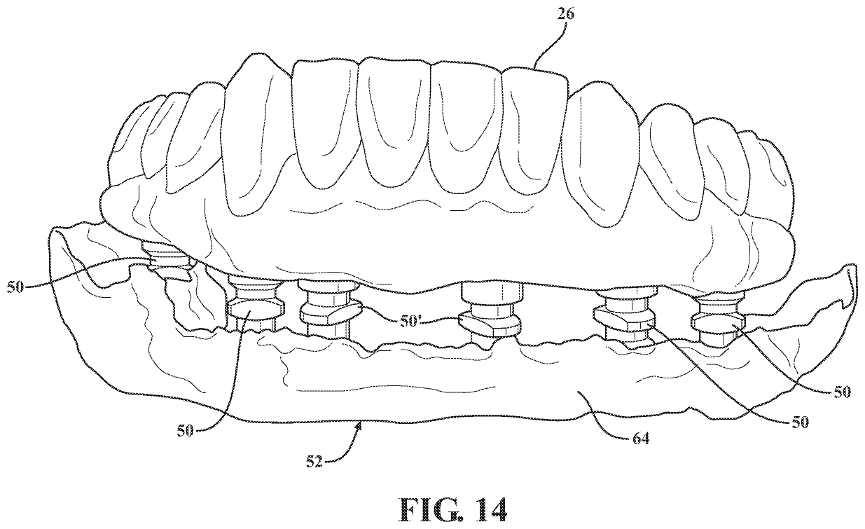

Typically, the fabrication step will be performed by a specialized lab, who then returns the completed dental prosthesis 26 to the practitioner for fitting to the patient. In cases where the practitioner has direct access to suitable manufacturing capabilities, such as medical-grade 3D printing/manufacturing equipment, the computer aided design and production of a final prosthesis 26 can be completed immediately, easily in less than 24 hours. The dental prosthesis 26 can be test fit on the physical model 52, as seen in FIG. 14. It is common practice to remove the replica soft tissue 64 from the physical model 52 to reveal the upper portions of the lab analogues 50. This will enable the practitioner/technician to verify that the prosthesis 26 makes precision contact with the exposed ends 55.

As mentioned, the ASD 56 provides a repeatable occlusion position and allows in vivo recording of the jaw relationship, VDO, and midline of the edentulous arch by an intraoral scanner 68. The ASD 56 not only works to record ideal occlusion, VDO and midline, but also enables seamless blending and merging of scans from the intraoral and extraoral environments. Moreover, it enables precise digital alignment of the physical model in an ideal relationship with the opposing arch.

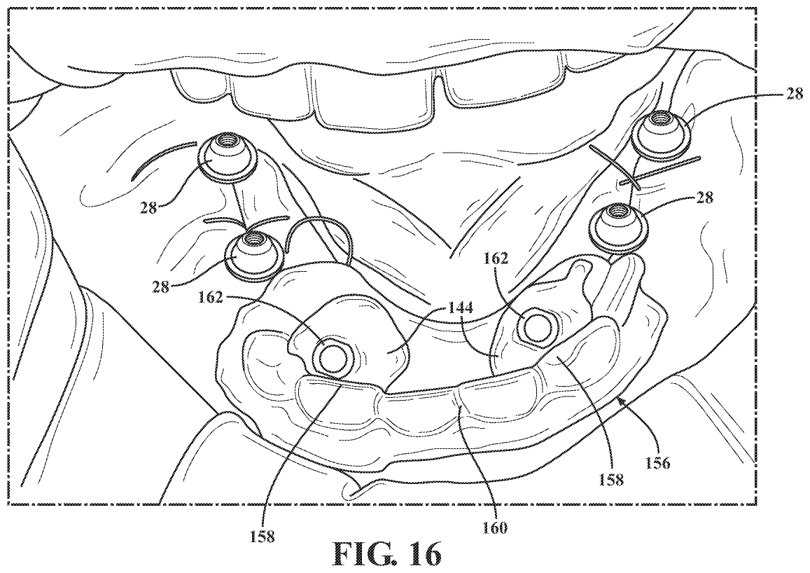

Construction methods other than that described in connection with FIGS. 9 and 10 are contemplated for the ASD 56. One such alternative method is illustrated in FIGS. 15 and 16, in which certain reference numbers previously presented are used for convenience but offset by 100. For example, the anterior scanning device (ASD) is referenced by the number 156.

In this example, the first and second cylinders 162 are attached to the first and second anterior implants 24′ exactly as with the previously mentioned cylinder 62. However, in this case, instead of building-up a wad using a hardening resin compound 64, a short-term dental appliance ID is provided. The short-term dental appliance ID may be of the so-called immediate denture type. The immediate denture ID is produced from a bite impression of the patient's arch taken during a pre-operative visit, and prior to extraction of any remaining teeth. From this impression, the dentist can creatively/artfully fill in missing teeth so that the immediate denture ID will have reasonable approximations of the patient's natural tooth profile. Moreover, the immediate denture ID will inherently include the VDO 158 and midline 160 indicators as elements of the natural teeth formations. The short-term dental appliance shown in FIG. 15 covers the full lower arch, but of course the upper full arch is also possible.

Holes are formed in the immediate denture ID to receive the two upstanding cylinders 162 in the anterior region of the patient's mouth, taking care to align the patient's anatomical midline with the VDO 158 and midline 160 features of the immediate denture ID. With this fit achieved, the cylinders 162 are bonded to the immediate denture ID using a curable bonding resin 144 or other suitable compound.

Once the bonding resin 144 has taken a hard set, the fasteners securing the cylinder 162 are removed, allowing the immediate denture ID to be removed and transferred to an ex vivo worktable. The portions distal of the canine regions, as well as the palate region, of the immediate denture ID are excised and discarded. Removing from the immediate denture ID the flanges and all teeth posterior to the incisors, leaving only an anterior fixed occlusion point, ensures the patient possesses a stable and repeatable occlusion and vertical dimension that can be assessed and adjusted by the healthcare provider if necessary. FIG. 16 shows these unneeded regions removed, leaving only the anterior portion of the immediate denture which has been re-secured to the implants 24′ via the cylinders 162. The remaining portion of the immediate denture ID is now the ASD 156.

As needed, changes can be made to the occlusion or vertical dimension by adding or subtracting materials as described above. That is, if needed, the ASD 156 is built-up in stages or increments until the lower facial height is properly established by occluding members in direct contact with the ASD 156. To the extent the VDO 158 and/or midline 160 of the immediate denture ID do not adequately align with patient's anatomical midline or VDO, the practitioner must fashion and mark a new scannable VDO 158 and midline 160 features on the ASD 156.

Once perfected, the ASD 156 is digitally scanned intraorally to capture the bite, vertical dimension, and midline as it was explained before and as it was depicted in FIG. 11. The ASD 156 is then transferred to the physical model 52 and scanned extra-orally, along with the rest of the model (FIG. 12). As previously explained, this dual-scan strategy with the same ASD 156 effectively tricks the scanning software into capturing the physical model 52 in occlusion. This yields precise scans and an accurate occlusion record without the need for external mounting of models. This method facilitates a seamless combining of data scanned intraorally, which captures jaw relationships within the patient's mouth, with data scanned extra-orally, which accurately captures implant positions on a verified model.

Yet another alternative construction method for the anterior scanning device is illustrated in FIGS. 17-22, in which certain reference numbers previously presented are used for convenience but offset by 200. For example, the anterior scanning device (ASD) is referenced by the number 256. This particular alternative method is available when the implants 24 have been placed using a guided surgery technique, from which a bone foundation guide 272 will have been previously anchored in place over the edentulous site (FIG. 17). Thus, the bone foundation guide 272 will have been placed in an earlier operation. The bone foundation guide 272 includes one or more precision-located mounting pads 274 upon which an implant drilling guide 276 (FIG. 18) and other fixtures, jigs or tools are attached to accomplish various operations.

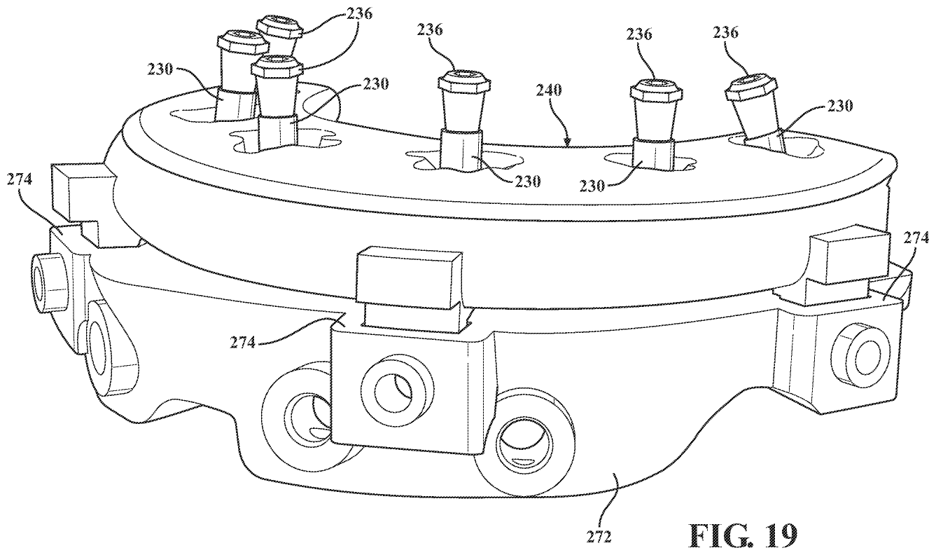

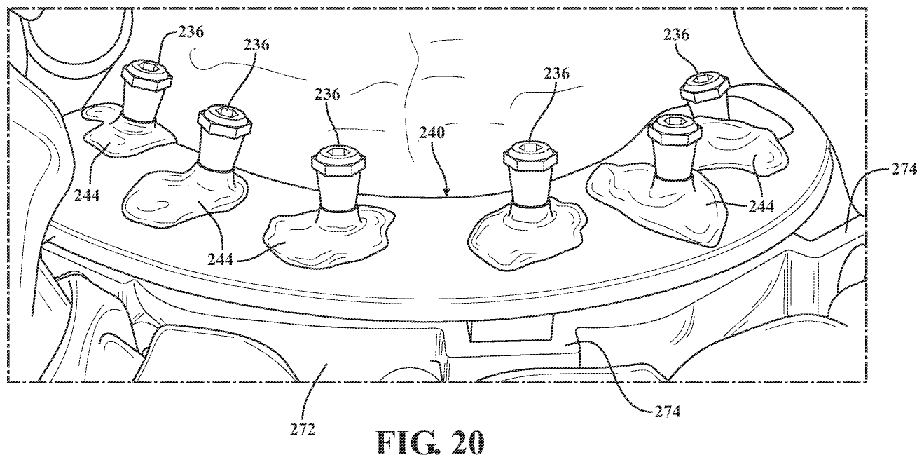

FIGS. 19-20 show formation of the bite impression using a pre-operatively planned, designed and milled connector plate 240. After coping impressions 230 have been secured to each multi-unit abutment 228 (see FIG. 21), the custom connector plate 240 is placed into registry with the bone foundation guide 272. The coping impressions 230 are bonded to the custom connector plate 240 using a curable bonding resin 244. Thereafter, the custom connector plate 240 is removed from the patient's mouth. The bone foundation guide 272 is also removed and its mounting locations sutured closed. At an ex vivo workstation, the custom connector plate 240 is modified to remove the registration features used to interlock with the bone foundation guide 272, namely the prongs received into the mounting pads 274. The modified connector plate 240 is then returned to an in vivo position and re-secured to the multi-unit abutments 228. With the bone foundation guide 272 now removed and mounting features discarded, there is space between the custom connector plate 240 and the soft tissue of the edentulous site within which to form the bite impression using suitable impression materials. From the completed bite impression, a physical model 52 can be constructed for use in the manner previously described.

Turning now to FIG. 21, the ASD 256 is shown being fitted upon the bone foundation guide 274. During the implant planning phase, the ASD 256 is designed and milled as a component of the detachable guided system. After attaching first and second cylinders 262 to the first and second anterior implants 24′, the ASD 256 is placed into registry with the bone foundation guide 272, as shown in FIG. 21. Next, the cylinders 262 are bonded to the ASD 256 using a curable bonding resin 244 or other suitable compound. Because the ASD 256 was designed during the earlier planning phase, the vertical dimension of occlusion 258, midline 260 and bite details are already incorporated as scannable surface features.

As needed, changes can be made to the occlusion or vertical dimension by adding or subtracting materials as described above. That is, to the extent the VDO 258 and/or midline 260 need adjustments to adequately align with patient's anatomical midline or VDO, the practitioner must fashion and mark a new scannable VDO 258 and midline 260 features on the ASD 256. The completed ASD 256 is then removed from the patient's mouth. The bone foundation guide 272 is also removed and its mounting locations sutured closed. This step will be coordinated with the creation of the bite impression, described above, so that once the bone foundation guide 272 is removed there is no need to reinstall it.

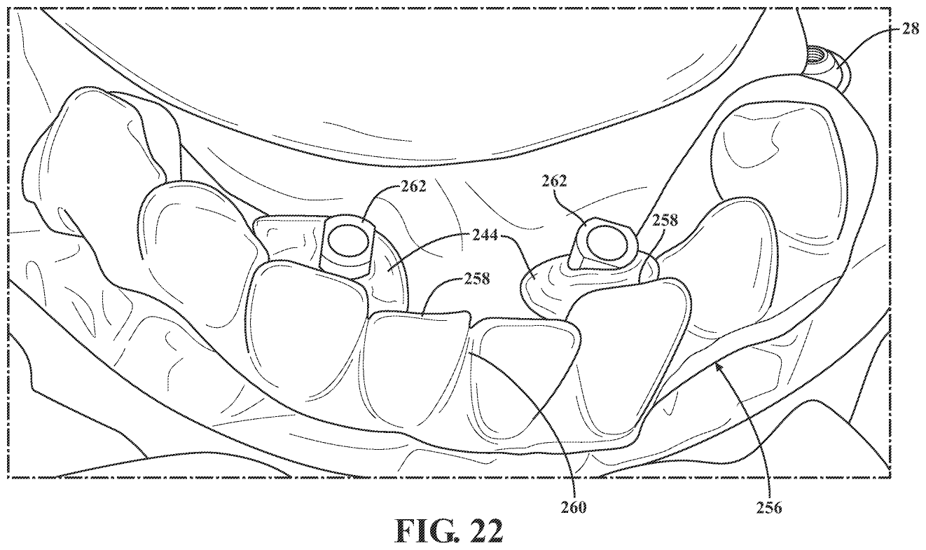

At an ex vivo location, the ASD 256 is modified to remove the registration features used to interlock with the bone foundation guide 272, then with the bone foundation guide 272 now removed, the ASD 256 is transferred in vivo and reattached to the multi-unit abutments 28′ via the cylinder 262. See FIG. 22. At this stage, the in vivo portion of the hybrid in vivo/ex vivo digital scan 52A can commence. Following this, the ASD 256 is transferred ex vivo to the physical model 52 (FIG. 12) where the ex vivo portion of the hybrid in vivo/ex vivo digital scan 52A takes place as previously described.

This invention describes a clinical technique and system well-suited for immediate implant 24 loading in edentulous patients. This invention combines advantages of intraoral scanning, an accurate cast model 52 ensuring the verification process and the passive fit of the permanent prosthesis 26 and a digitalization of the model 52 using one or more high-resolution 3D scanners. A key to the success of this method occurs during the hybrid in vivo/ex vivo digital scan 52A, where the intraoral scanner 68 is seemingly tricked or fooled to generate a single scan file beginning intra orally (in vivo) but concluding on the physical model 52 (ex vivo), with the ASD 56, 156, 256 serving as a common link or bridge between the in vivo and ex vivo portions. This invention enables predictable manufacturing with high accuracy of both provisional (temporary) and permanent (long-term/durable) prosthesis 26 that can be verified on the model 52. Workflow is simplified, so photogrammetry or facial scanning are not necessarily required.

Computer aided manufacturing of the final prosthesis 26 can be verified and delivered to the patient rapidly—in some cases possibly same day or next day. The invention offers a cost-effective option leveraging the availability of affordable, in-office 3D printing or PMMA milling equipment.

Same or next-day provisionalization of full-arch implant-supported prostheses has traditionally posed many challenges and required an unreasonable amount of time from the provider. In today's world of implant dentistry, increasing numbers of patients are interested in treating ailing and failing dentitions with full-arch implant-supported prostheses. These patients are also expecting efficient treatment, with provisionals that are comfortable and aesthetic during implant healing periods.

Traditional techniques for restoration of the implant-supported full-arch have been burdensome to the provider, involving painstaking procedures and significant time both chairside and in the lab between visits. Digital dentistry has proven to be a revolutionary introduction to the practice of dentistry and promises reduced treatment time and elimination of messy and burdensome traditional techniques. However, even digital dentistry has fallen short in some aspects when it comes to immediate provisionalization of the implant-supported full-arch. Inaccuracies present in full-arch scan data, merging of intraoral and extraoral scans, and recording of VDO, occlusion and midline into the scan have rendered this process difficult for providers striving to complete this process digitally.

This invention presents a time sparing, cost effective and accurate treatment. By this invention, clinically easy delivery of the provisional full arch prosthesis 26 is possible in the day of surgery or soon thereafter. This invention uniquely combines the advantages of digital and analog dentistry. The ASD 56, 156, 256 enables the creation of a hybrid in vivo/ex vivo digital scan 52A, which is then used in a protocol of post-surgical provisionalization that eliminates many of the challenges traditionally faced, drastically reduces chair time, and increases the accuracy of gathered data to improve outcomes.

In this innovative technique, these challenges are overcome by use of an ASD 56. The ASD 56 provides a repeatable and fixed occlusal point that can record VDO, jaw relationship, and midline. The ASD 56 also works to improve the accuracy of digital scans for the full arch, as it renders a seamless hybrid in vivo/ex vivo digital scan 52A. Easily transferred from the patient's oral cavity to a verified model 52, the ASD 56 enables the scanner 68 to continue the scan extra-orally. Extra-orally, a precise physical model 52 is easily and clearly captured away from saliva and blood present in the mouth. When linked with the opposing arch scan, the hybrid scan reveals the model 52 in the correct occlusal position. This hybrid in vivo/ex vivo digital scan 52A can then be subsequently merged with an ex vivo re-scan of the physical model 52 sans the ASD, thereby further increasing the accuracy of the resulting data. Using a verified physical model 52 draws on the strengths of analog practices, while the digital approach to obtaining data and designing the restoration 26 utilizes the full potential of modern dental tools to enhance accuracy, reduce wait time and eliminate messy materials.

The method offers an efficient approach to obtaining accurate digital data for any partial or any full-arch implant restoration. Further, this method can be utilized at any point in the healing period. This method is useful for immediate loading of the full arch. However, it is equally applicable shortly after implant placement for early loading, or even after full healing time is complete, for final restoration in a delayed fashion. The method presents an efficient, seamless, and versatile approach to restoration, applicable to a wide variety of cases at any point in the post-surgical healing process.

In conclusion, the protocol described here presents an efficient and effective method for next-day provisionalization of full-arch implant-supported prostheses via digital scanning and design. This method eliminates many of the technique-sensitive aspects of traditional methods for restoration of the implant-supported full arch. Meanwhile, this method also preserves the best qualities of traditional analog and digital methods, creating an enhanced technique that can be accepted by both digital- and analog-preferring dentists.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. A hybrid in vivo/ex vivo method for determining the size and shape of a dental prosthesis to be fixed to an edentulous site in a patient's mouth in which have been placed a plurality of dental implants in the mandible or maxilla, the plurality of implants including first and second anterior implants located near the area designated for incisor teeth, said method comprising the steps of:
ex vivo casting a physical model from a bite impression, said casting step including encasing a plurality of lab analogues in a curable compound, the physical model comprising a generally exact scale replica of the edentulous site with each encased lab analogue corresponding in relative location and orientation with a respective one of the dental implants, the physical model having a first anterior lab analogue corresponding in relative location and orientation to the first anterior implant and a second anterior lab analogue corresponding in relative location and orientation to the second anterior implant,
in vivo attaching an anterior scanning device (ASD) to the first and second anterior implants, affixing a scannable marker on the ASD to indicate at least one of a vertical dimension of occlusion and a midline,
creating a hybrid in vivo/ex vivo digital scan capturing the scannable marker of the ASD, said step of creating a hybrid in vivo/ex vivo digital scan including in vivo digitally recording the ASD using an intraoral scanner, and then detaching the ASD from the first and second anterior implants, and then ex vivo attaching the ASD to the first and second anterior lab analogues of the physical model, and then ex vivo scanning the physical model with attached ASD.

2. The method of claim 1 wherein said step of in vivo attaching an ASD comprises the steps of: attaching a first cylinder to the first anterior implant and a second cylinder to the second anterior implant, monolithically encasing the first and second anterior cylinders in a hardening resin compound, and then incrementally adding supplemental hardening resin compound to the monolithic encasement until a vertical dimension of occlusion is achieved.

3. The method of claim 1 wherein said step of in vivo attaching an ASD comprises the steps of: attaching a first cylinder to the first anterior implant and a second cylinder to the second anterior implant, bonding a short-term dental appliance to the first and second anterior cylinders, and excising unneeded portions of the short-term dental appliance.

4. The method of claim 1 wherein said step of in vivo attaching an ASD includes coupling the ASD to a bone foundation guide.

5. The method of claim 1 further including in vivo attaching a coping impression to each implant so that there is a space between each coping impression and the next adjacent coping impression, the coping impression attached to the first anterior implant comprising a first anterior coping impression, the coping impression attached to the second anterior implant comprising a second anterior coping impression,
in vivo embedding the coping impressions within a curable impression material, said embedding step including overlaying the edentulous site with the impression material, solidifying the impression material into a rigid monolithic bite impression containing the coping impressions, the bite impression having a negative impression of the edentulous site,
relocating the bite impression from in vivo to ex vivo, the negative impression of the edentulous site exposing each coping impression,
ex vivo connecting a lab analogue to each coping impression, the lab analogue attached to the first anterior coping impression comprising a first anterior lab analogue, the lab analogue attached to the second anterior coping impression comprising a second anterior lab analogue, and
in vivo spanning the space between each coping impression and the next adjacent coping impression with a connector plate.

6. The method of claim 5 wherein said in vivo spanning step includes positioning the connector plate between a locking groove and an upstanding end of each associated coping impression.

7. The method of claim 5 further including in vivo bonding the connector plate to a coping impression.

8. The method of claim 7 wherein said in vivo bonding step includes applying a curable bonding resin at the juncture of each coping impression with the connector plate.

9. The method of claim 5 wherein the connector plate has a thin body of generally elliptical shape.

10. The method of claim 9 wherein the connector plate has a plurality of apertures adapted to receive a coping impression.

11. The method of claim 5 wherein said in vivo spanning step includes positioning a plurality of connector plates over a plurality of coping impressions, and overlapping two adjacent connector plates with one another.

12. The method of claim 1 wherein said in vivo detaching step includes pausing the intraoral scanner, and said step of ex vivo scanning the physical model includes re-activating the intraoral scanner.

13. The method of claim 1 wherein following said step of creating a hybrid in vivo/ex vivo digital scan, further including the steps of:
removing the ASD from the physical model,
installing a scan body to each lab analogue,
re-scanning physical model with attached scan bodies but without ASD, and
merging the re-scan onto the hybrid in vivo/ex vivo digital scan in aligned overlay.

14. The method of claim 1 further including the step of scanning the opposing arch in relationship to the ASD, and following said step of creating a hybrid in vivo/ex vivo digital scan, further including the steps of:
removing the ASD from the physical model,
installing a scan body to each lab analogue,
re-scanning physical model with attached scan bodies but without ASD, and
merging the re-scan onto the hybrid in vivo/ex vivo digital in aligned overlay.

15. A hybrid in vivo/ex vivo method for determining the size and shape of a dental prosthesis to be fixed to an edentulous site in a patient's mouth in which have been placed a plurality of dental implants in the mandible or maxilla, the plurality of implants including first and second anterior implants located near the area designated for incisor teeth, said method comprising the steps of:
in vivo attaching a coping impression to each implant so that there is a lateral space between each coping impression and the next adjacent coping impression, the coping impression attached to the first anterior implant comprising a first anterior coping impression, the coping impression attached to the second anterior implant comprising a second anterior coping impression,
in vivo spanning the lateral space between each coping impression and the next adjacent coping impression with a connector plate, the connector plate having at least one aperture adapted to receive an upstanding end of the coping impression, applying a curable bonding resin at the juncture of each coping impression with the connector plate,
in vivo embedding the coping impressions within a curable impression material, said embedding step including overlaying the edentulous site with the impression material, solidifying the impression material into a rigid monolithic bite impression containing the coping impressions, the bite impression having a negative impression of the edentulous site,
relocating the bite impression from in vivo to ex vivo, the negative impression of the edentulous site exposing each coping impression,
ex vivo connecting a lab analogue to each coping impression, the lab analogue attached to the first anterior coping impression comprising a first anterior lab analogue, the lab analogue attached to the second anterior coping impression comprising a second anterior lab analogue,
ex vivo casting a physical model from the bite impression, said casting step including encasing the lab analogues in a curable compound, the physical model comprising a generally exact scale replica of the edentulous site with each encased lab analogue corresponding in relative location and orientation with a respective one of the dental implants, the physical model having the first anterior lab analogue corresponding in relative location and orientation to the first anterior implant and the second anterior lab analogue corresponding in relative location and orientation to the second anterior implant,
in vivo attaching an anterior scanning device (ASD) to the first and second anterior implants, affixing a scannable marker on the ASD to indicate at least one of a vertical dimension of occlusion and a midline,
said step of creating a hybrid in vivo/ex vivo digital scan including in vivo digitally recording the ASD using an intraoral scanner, and then detaching the ASD from the first and second anterior implants, and then ex vivo attaching the ASD to the physical model, and then ex vivo scanning the physical model with attached ASD.

16. The method of claim 15 wherein following said step of creating a hybrid in vivo/ex vivo digital scan, further including the steps of:
removing the ASD from the physical model,
installing a scan body to each lab analogue,
re-scanning physical model with attached scan bodies but without ASD, and
merging the re-scan onto the hybrid in vivo/ex vivo digital scan in aligned overlay.

17. The method of claim 15 further including the step of scanning the opposing arch in relationship to the ASD, and following said step of creating a hybrid in vivo/ex vivo digital scan, further including the steps of:
removing the ASD from the physical model,
installing a scan body to each lab analogue,
re-scanning physical model with attached scan bodies but without ASD, and
merging the re-scan onto the hybrid in vivo/ex vivo digital in aligned overlay.

18. The method of claim 15 wherein said step of in vivo attaching an ASD comprises the steps of: attaching a first cylinder to the first anterior implant and a second cylinder to the second anterior implant, monolithically encasing the first and second anterior cylinders in a hardening resin compound, and then incrementally adding supplemental hardening resin compound to the monolithic encasement until a vertical dimension of occlusion is achieved.

19. The method of claim 15 wherein said step of in vivo attaching an ASD comprises the steps of: attaching a first cylinder to the first anterior implant and a second cylinder to the second anterior implant, bonding a short-term dental appliance to the first and second anterior cylinders, and excising unneeded portions of the short-term dental appliance.

20. The method of claim 15 wherein said step of in vivo attaching an ASD includes concurrently coupling the ASD to a bone foundation guide and to the first and second anterior implants.
